(19) United States
(12) Patent Application Publication
(10) Pub. No.: US 2023/0366988 A1
(43) Pub. Date: Nov. 16, 2023

(54) LOW PROFILE LIDAR SYSTEMS WITH MULTIPLE POLYGON SCANNERS

(71) Applicant: Innovusion, Inc., Sunnyvale, CA (US)

(72) Inventors: Yimin Li, Cupertino, CA (US); Yufeng Li, Milpitas, CA (US); Junwei Bao, Los Altos, CA (US)

(21) Appl. No.: 18/196,405

(22) Filed: May 11, 2023

Related U.S. Application Data
(60) Provisional application No. 63/391,300, filed on Jul. 21, 2022.
(60) Provisional application No. 63/341,415, filed on May 12, 2022.

(51) Int. Cl. G01S 7/481; G01S 17/931

(52) U.S. Cl. CPC G01S 7/4817; G01S 17/931

(57) ABSTRACT

A light detection and ranging (LiDAR) scanning system used with a moveable platform is provided. The LiDAR scanning system comprises one or more light sources; and one or more optical core assemblies optically coupled to the one or more light sources. At least one optical core assembly of the one or more optical core assemblies comprises: an optical core assembly enclosure at least partially disposed in the moveable platform; a plurality of optical polygon elements, and one or more moveable reflective elements. The combination of the plurality of optical polygon elements and the one or more moveable reflective elements form one or more light steering devices operative to scan one or more field-of-views of the LiDAR system. The plurality of optical polygon elements, the one or more moveable reflective elements, and at least one of transmitting and receiving optics are disposed within the optical core assembly enclosure.

### CROSS-REFERENCE TO RELATED APPLICATIONS

This application claims priority to U.S. Provisional Pat. Application Serial No. 63/341,415, filed May 12, 2022, entitled “LOW PROFILE LIDAR DESIGN WITH DUAL POLYGON SCANNERS”, and U.S. Provisional Pat. Application Serial No. 63/391,300, filed Jul. 21, 2022, entitled “LOW PROFILE LIDAR DESIGN WITH MULTIPLE POLYGON SCANNERS”. The contents of both applications are hereby incorporated by reference in their entireties for all purposes.

### FIELD OF THE TECHNOLOGY

This disclosure relates generally to optical scanning and, more particularly, to a light detection and ranging (LiDAR) scanning system having multiple polygon scanners.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminates an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

LiDAR systems are often mounted to a vehicle or other moveable platforms. A low profile LiDAR system (e.g., a profile having less than 45 mm in vertical height) is typically desired for design aesthetics and reduction of aerodynamic drag. In some embodiments of the low profile LiDAR design, an optical core assembly includes multiple polygon scanners. The transceiver is placed side-by-side with the multiple polygon scanners. As a result, the overall height of the optical core assembly of the LiDAR system can be reduced. In addition, each polygon scanner in an optical core assembly can operate at a reduced speed, while producing more scanlines together. Each polygon scanner individually may cover a smaller range of FOV but taken together can cover an increased range of FOV, compared to using just a single polygon scanner. The overall performance of the LiDAR system having multiple polygon scanners can therefore be enhanced.

In some embodiments, a light detection and ranging (LiDAR) scanning system used with a moveable platform is provided. The system comprises one or more light sources; and one or more optical core assemblies optically coupled to the one or more light sources. At least one optical core assembly of the one or more optical core assemblies comprises: an optical core assembly enclosure at least partially disposed in the moveable platform; a plurality of optical polygon elements, and one or more moveable reflective elements. The combination of the plurality of optical polygon elements and the one or more moveable reflective elements form one or more light steering devices operative to scan one or more field-of-views of the LiDAR system. The system further comprises transmitting and receiving optics. The plurality of optical polygon elements, the one or more moveable reflective elements, and at least some of transmitting and receiving optics are disposed within the optical core assembly enclosure.

In some embodiments, a vehicle comprising a LiDAR scanning system is provided. The system comprises one or more light sources; and one or more optical core assemblies optically coupled to the one or more light sources. At least one optical core assembly of the one or more optical core assemblies comprises: an optical core assembly enclosure at least partially disposed in the moveable platform; a plurality of optical polygon elements, and one or more moveable reflective elements. The combination of the plurality of optical polygon elements and the one or more moveable reflective elements form one or more light steering devices operative to scan one or more field-of-views of the LiDAR system. The system further comprises transmitting and receiving optics. The plurality of optical polygon elements, the one or more moveable reflective elements, and at least some of transmitting and receiving optics are disposed within the optical core assembly enclosure.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7A is a diagram illustrating a front view of a vehicle mounted with one or more optical core assemblies of one or more LiDAR scanning systems at least partially integrated in the vehicle roof, according to some embodiments.

FIG. 7B illustrates a side view of a vehicle and positions for mounting one or more optical core assemblies of one or more LiDAR scanning systems, according to some embodiments.

FIGS. 7C and 7D illustrate different embodiments of mounting an optical core assembly to a vehicle roof.

FIG. 8 is a block diagram illustrating an example of an optical core assembly of a LiDAR scanning system having multiple polygon elements, according to some embodiments.

FIGS. 9A-9G illustrate partial field-of-views scanned by an optical core assembly having multiple polygon elements, according to various embodiments.

FIG. 10 is a diagram illustrating a configuration for at least a portion of an optical core assembly of a LiDAR scanning system according to various embodiments.

FIG. 11 is a diagram illustrating another configuration for at least a portion of an optical core assembly of a LiDAR scanning system according to various embodiments.

FIG. 12 is a diagram illustrating another configuration for at least a portion of an optical core assembly for a LiDAR scanning system according to various embodiments.

FIG. 13 is a block diagram illustrating another example optical core assembly of a LiDAR scanning system having multiple polygon elements, according to some embodiments.

FIG. 14A is a block diagram illustrating another example optical core assembly of a LiDAR scanning system having multiple polygon elements, according to some embodiments.

FIG. 14B is a diagram illustrating a perspective view of a variable angle multiple facet polygon (VAMFP) used in the example optical core assembly in FIG. 14A.

FIG. 14C is a diagram illustrating side views of facets of a VAMFP in FIG. 14B.

FIG. 14D is a diagram illustrating an FOV distribution for a LiDAR scanning system having a VAMFP.

FIG. 15A illustrates an example configuration of multiple light steering devices and transmitting and receiving optics in an optical core assembly, according to some embodiments.

FIG. 15B illustrates an example configuration of multiple light steering devices and transceiver assemblies in an optical core assembly, according to some embodiments.

FIGS. 16A and 16B illustrate scanline patterns obtained based on scanning of FOVs by using the multiple polygon elements in an optical core assembly of a LiDAR scanning system, according to some embodiments.

FIG. 17 illustrates maximum detection ranges of a LiDAR scanning system having multiple light steering devices, according to some embodiments.

FIG. 18 is a flowchart illustrating a method performed by a LiDAR scanning system.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first polygon mirror could be termed a second polygon mirror and, similarly, a second polygon mirror could be termed a first polygon mirror, without departing from the scope of the various described examples. The first polygon mirror and the second polygon mirror can both be polygon mirrors and, in some cases, can be separate and different polygon mirrors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

LiDAR systems designed to be mounted toward the front of a vehicle tend to have a symmetrical Field-of-View (FOV) optimized for front object detection. LiDAR systems designed to be mounted at or near the top of a vehicle also preferably should have a low profile to minimize intrusion into the vehicle’s roof design aesthetics and the vehicle cabin structure, and to reduce the aerodynamic drag caused by the protrusion of the LiDAR systems. To obtain a low profile LiDAR system (e.g., an optical core assembly of the LiDAR system having about or less than 45 mm in its vertical height), the vertical height needs to be reduced as much as possible while satisfying the scanning performance requirements. In LiDAR system designs, the vertical height of the LiDAR system may often be difficult to reduce due to stacking of the optical scanning elements (e.g., a polygon mirror scanner or simply polygon scanner) onto the transceiver. Furthermore, the number of scanlines and scanline density of scanlines obtained from the LiDAR system scanning may be difficult to improve due to their strong dependence on the polygon scanner’s rotational speed. A high polygon rotation speed typically results in an increased power consumption and heat generation, and possibly lower reliability and reduced usable lifetime. To resolve or reduce the aforementioned difficulties, an improved low-profile LiDAR design with multiple polygon scanners is described in this disclosure. In some embodiments of the low profile LiDAR design, multiple polygon scanners are disposed in a lateral arrangement. In addition, the transceiver can also be placed side-by-side with the multiple polygon scanners. As a result, the overall height of the LiDAR system can be reduced to about or less than, for example, 45 mm. In addition, each polygon scanner can operate at a reduced speed, while producing more scanlines together. Each polygon scanner individually may cover a smaller range of FOV but taken together can cover an increased FOV. The term polygon scanner is used interchangeably with polygon element, polygon mirror, or simply polygon.

Embodiments of the present invention are described below. In various embodiments of the present invention, a light detection and ranging (LiDAR) scanning system used with a moveable platform is provided. The system comprises one or more light sources; and one or more optical core assemblies optically coupled to the one or more light sources. At least one optical core assembly of the one or more optical core assemblies comprises: an optical core assembly enclosure at least partially disposed in the moveable platform; a plurality of optical polygon elements, and one or more moveable reflective elements. The combination of the plurality of optical polygon elements and the one or more moveable reflective elements form one or more light steering devices operative to scan one or more field-of-views of the LiDAR system. The system further comprises transmitting and receiving optics. The plurality of optical polygon elements, the one or more moveable reflective elements, and at least some of transmitting and receiving optics are disposed within the optical core assembly enclosure.

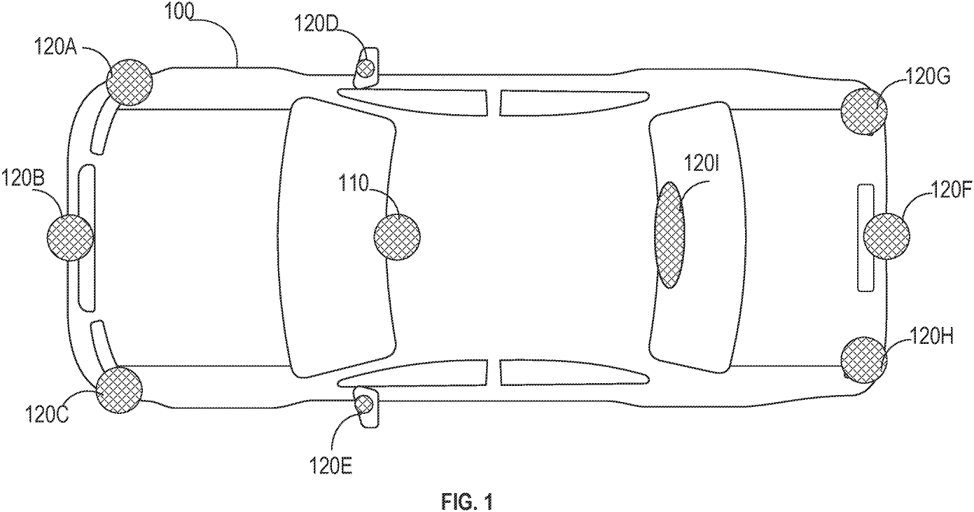

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, an unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver’s intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver’s intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but has no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

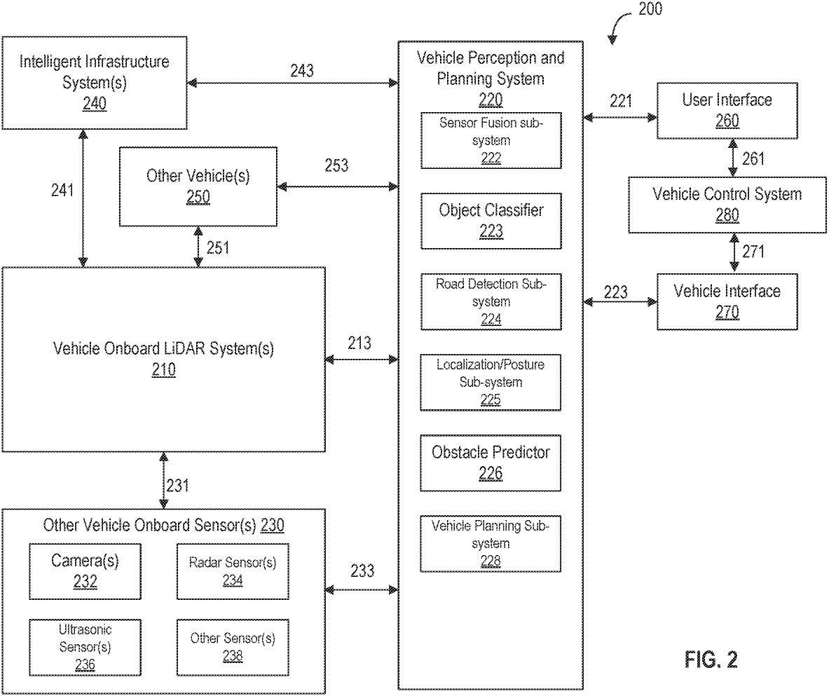

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle’s control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitate producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mounted on, or integrated to, a vehicle at any location (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object’s position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located near the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mounted on, or integrated to, a vehicle at any location (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure objects located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any location (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle’s headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine the position of the vehicle and the vehicle’s posture. For example, using sensor data from LiDAR system(s) 210, camera(s) 232, and/or GPS data, localization and vehicle posture sub-system 225 can determine an accurate position of the vehicle on the road and the vehicle’s six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle’s location. For instance, using the HD maps, localization and vehicle posture sub-system 225 can determine precisely the vehicle’s current position (e.g., which lane of the road the vehicle is currently in, how close it is to a curb or a sidewalk) and predict vehicle’s future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle’s trajectory intersects with the vehicle’s current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle’s current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle’s steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle’s location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

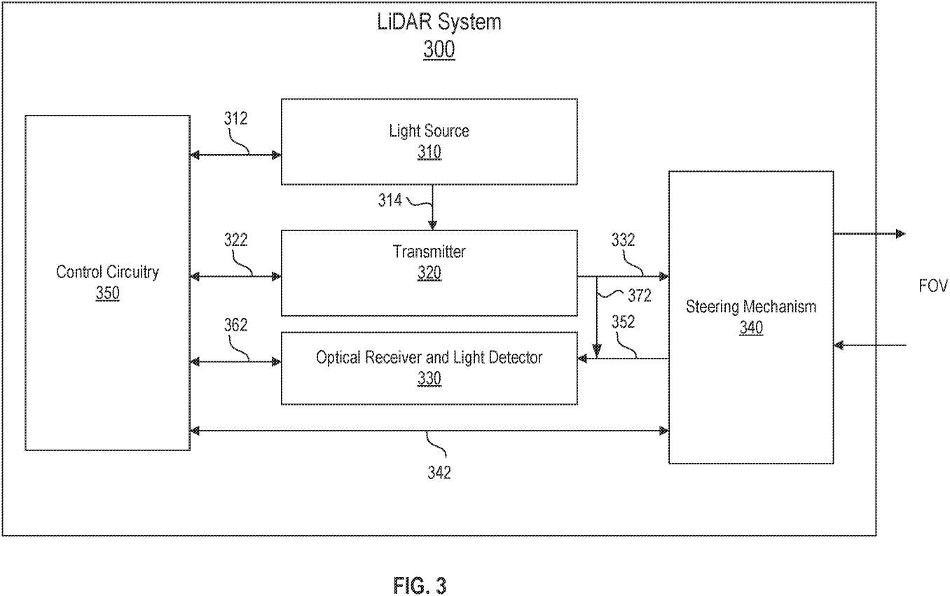

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object’s range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

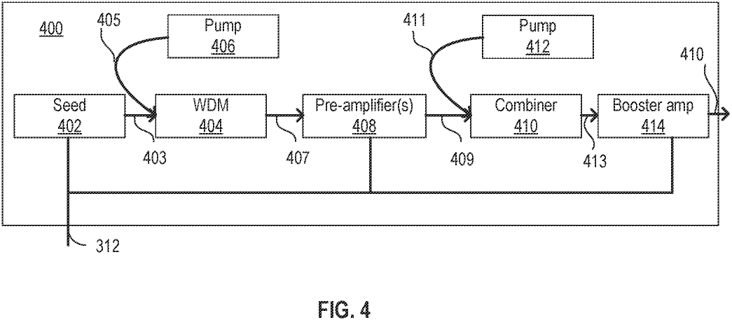

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The output light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon, or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector’s capability of maintaining linear relationship between input optical signal power and the detector’s output. A detector having good linearity can maintain a linear relationship over a large dynamic input optical signal range.

To achieve desired detector characteristics, configurations or customizations can be made to the light detector’s structure and/or the detector’s material system. Various detector structures can be used for a light detector. For example, a light detector structure can be a PIN based structure, which has an undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector’s internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering with the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image, or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and /or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, buses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

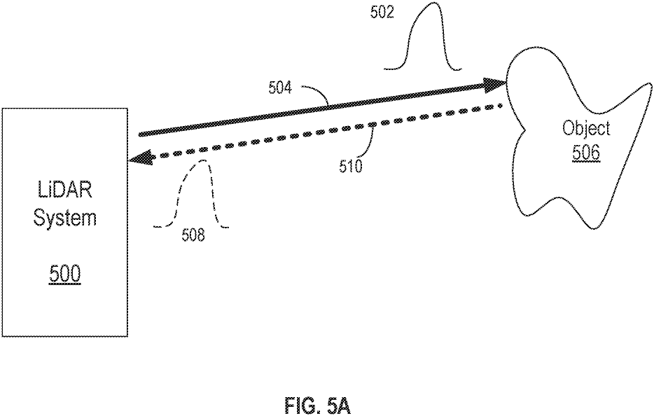

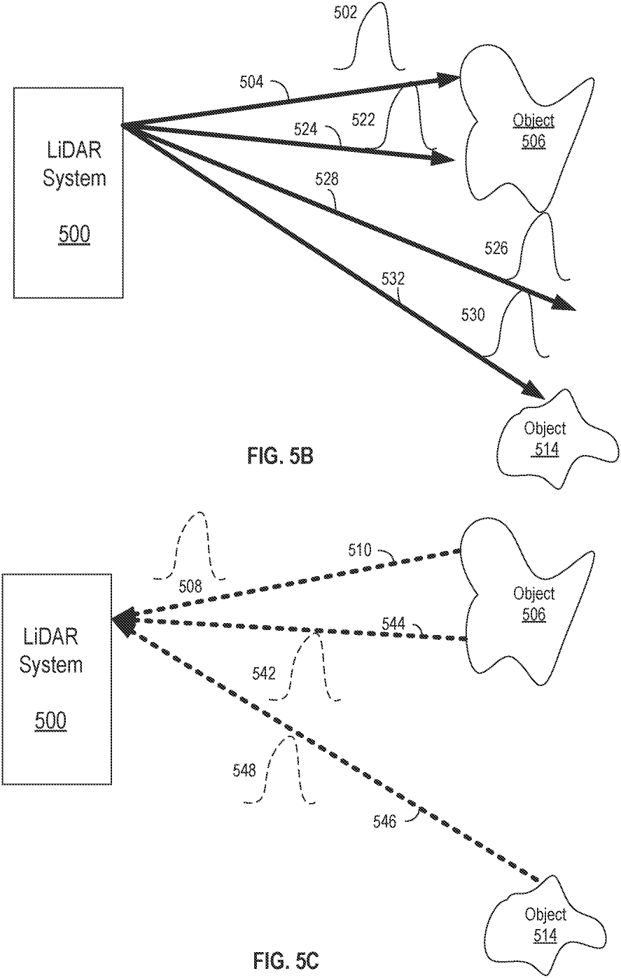

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 1-18, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

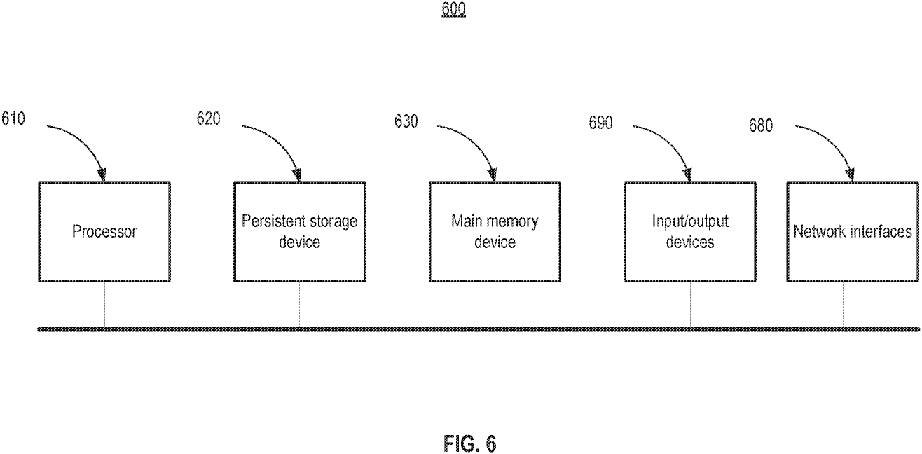

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 1-18 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 1-18. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

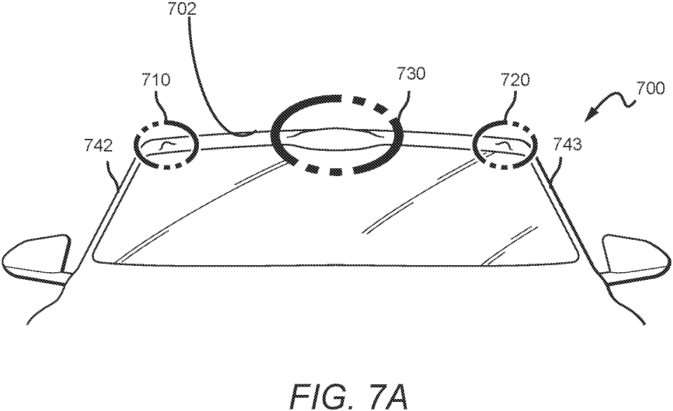

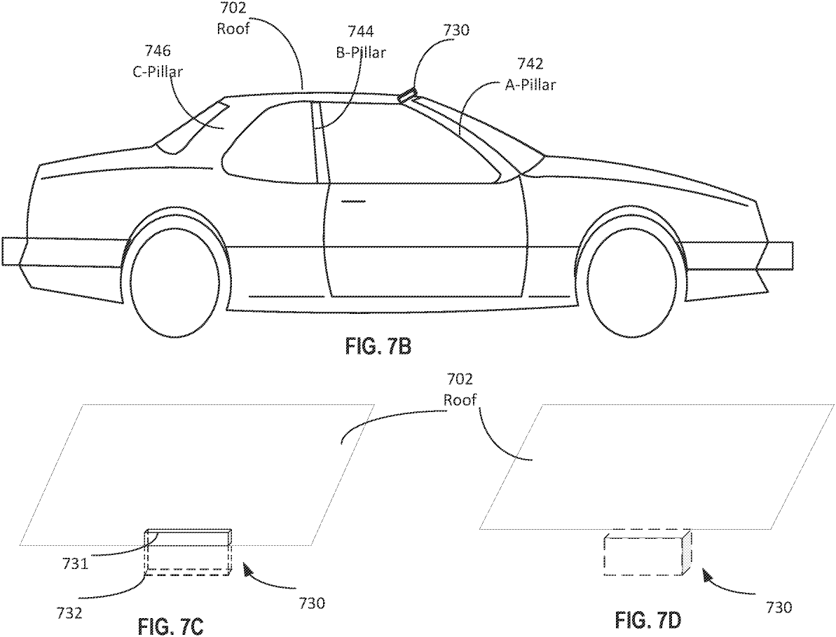

A LiDAR scanning system can be mounted to, or integrated with, a moveable platform. A moveable platform comprises one or more of a vehicle, a robot, an unmanned aviation vehicle (UAV), roller skates, a skateboard, a scooter, a bicycle, a tricycle, an aircraft, a watercraft, or a spacecraft. The below descriptions use a vehicle for illustration but can be applied in principle to other moveable platforms. FIG. 7A is a diagram illustrating a front view of a vehicle 700 mounted with one or more optical core assemblies of one or more LiDAR scanning systems at least partially integrated in the vehicle roof, according to some embodiments. FIG. 7B illustrates a side view of a vehicle 700 and positions for mounting one or more optical core assemblies of one or more LiDAR scanning systems, according to some embodiments. FIGS. 7C and 7D illustrate different embodiments of mounting an optical core assembly to a vehicle roof 702.

With reference to FIGS. 7A-7C, at least a part of a LiDAR scanning system may be positioned at different locations of the vehicle, such as two corner positions located at the left and right sides of the vehicle 700, or a center position. A LiDAR scanning system, as described above, may include many components such as a light source, a transmitter, a steering mechanism, an optical receiver, etc. In some embodiments disclosure herein, certain components of the LiDAR scanning system may be assembled together to form an optical core assembly. An optical core assembly includes at least a plurality of optical polygon elements. It may also include other optics such as moveable reflective elements, transmitting optics, and receiving optics. Embodiments of an optical core assembly are described in more details below. FIGS. 7A-7C are described using optical core assembly as an example of a part of a LiDAR scanning system. But it is understood that other components of the LiDAR scanning system may also be disposed at different locations of the vehicle 700, including those positions shown in FIGS. 7A-7C.

As shown in FIGS. 7A-7B, optical core assemblies 710 and 720 can be positioned proximate to one or more pillars of the vehicle roof 700. For instance, optical core assemblies 710 and 720 may be disposed at the vehicle roof 702 proximate to A-pillar 742, B-pillar 744, C-pillar 746, or another pillar (e.g., D-pillar if a vehicle has one). Each optical core assemblies 710 and 720 includes, for example, an enclosure and a plurality of optical polygon elements. It may also include one or more moveable reflective elements, transmitting optics, and/or receiving optics. In some embodiments, one or more pillars of the vehicle roof 702 may include first and second complementary pillars located at the two sides of the vehicle 700. And one or more optical core assemblies may be positioned proximate to the complementary pillars. As shown in FIG. 7A, a first optical core assembly 710 may be positioned proximate to A-pillar 742 at the right side of vehicle 700, and a second optical core assembly 720 may be positioned proximate to a complementary A-pillar 743 on the left side of the vehicle 700. Also as shown in FIG. 7A, another optical core assembly 730 may be positioned approximately equidistant between the two complementary A-pillars 742 and 743. For example, the optical core assembly 730 can be positioned at a center location on roof 702, which may be the maximum elevation position of vehicle 700.

In some embodiments, an optical core assembly of a LiDAR scanning system can be at least partially integrated with the vehicle roof. As one example shown in FIG. 7C, at least a portion 731 or a side surface of the optical core assembly 730 protrudes outside of the vehicle roof 702 to facilitate scanning of light. As described below in greater detail, the optical core assembly 730 can be configured to reduce or minimize the overall height or at least the height of the portion 731 that protrudes outside of the vehicle roof 702, thereby reducing the aerodynamic impact to the vehicle 700, to improve the aesthetic aspects of the vehicle 700, and to facilitate better integration of the LiDAR scanning system into vehicle 700. As another example shown in FIG. 7D, the optical core assembly 730 may be fully embedded or integrated inside the vehicle underneath the vehicle roof 702, such that there is no or minimum impact to the aerodynamic performance of the vehicle. FIGS. 7B and 7C illustrate that in some examples, the vehicle roof 702 (or any moveable platform) has planar surface. The planar surface can have a substantially horizontal profile (e.g., a horizontal profile substantially parallel to a road surface). In some examples, the roof 702 may have a complex surface profile. For instance, roof 702 may have a substantially flat surface in the middle portion but curved surfaces toward front and back of the vehicle. Roof 702 also may have a complex surface profile to accommodate, for example, a sliding window, a roll bar or halo, etc.

With reference back to FIG. 7A, in some embodiments, optical core assemblies 710 and 720 have two different FOVs. The two different FOVs may be overlapping FOVs in the front direction for full coverage and for redundancy. In one embodiment, the two FOVs may overlap by about 10-60 degrees. In some embodiments, the optical core assemblies 710 and 720 mounted at the two sides of vehicle root 702 are configured to detect far objects in the straight front direction. In one embodiment, one or more LiDAR systems comprising optical core assemblies 710 and 720 are configured to detect objects located at a 200-meter or 250-meter distance (or more) with a 10% reflection rate. In another embodiments, the LiDAR system comprising optical core assembly 730 may be configured to detect objects in a far distance (e.g., more than 200 meters) and the LiDAR systems comprising optical core assemblies 710 and/or 720 are configured to detect objects in a near distance (e.g., up to 50 meters).

With reference still to FIG. 7A, in some embodiments, one or more LiDAR systems comprising the optical core assemblies 710 and 720 have a large horizontal FOV to provide both side and front detection coverage. For example, the one or more LiDAR systems comprising optical core assemblies 710 and 720 can be configured to have at least a 120° FOV in the horizontal direction and/or at least 25° FOV in the vertical direction. In addition, with reference to FIGS. 7A-7C, similar to described above with respect to optical core assembly 730, optical core assemblies 710 and 720 can be configured to have a minimal vertical height to reduce aerodynamic drag. For instance, the vertical height can be configured to be less than 50 mm or 45 mm.

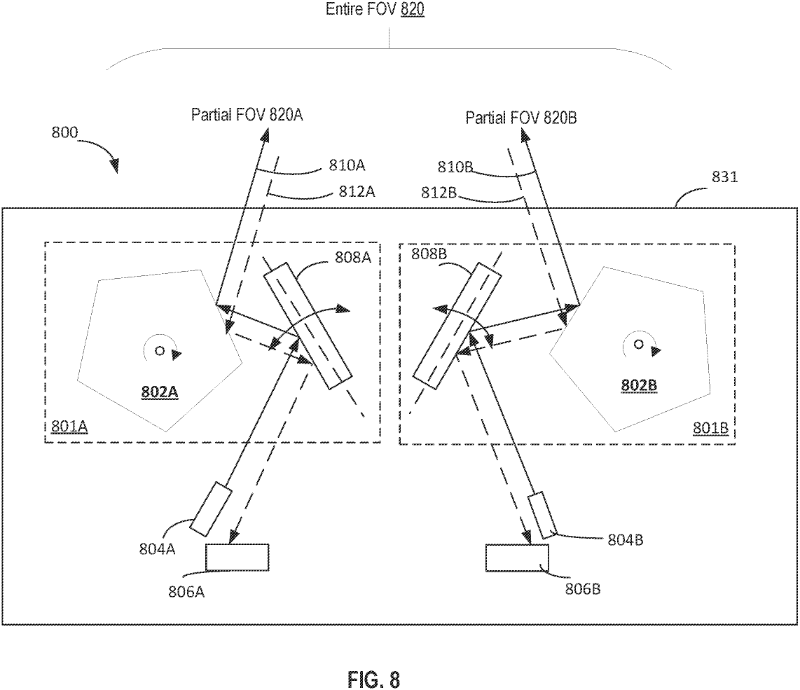

FIG. 8 is a block diagram illustrating an example optical core assembly 800 of a LiDAR scanning system having multiple polygon elements, according to some embodiments. Optical core assembly 800 can be used to implement optical core assemblies 710, 720, and 730 described above or any other optical core assemblies mountable to a moveable platform. In some embodiments, optical core assembly 800 is optically coupled to one or more light sources (not shown in FIG. 8). As shown in FIG. 8, in some embodiments, optical core assembly 800 includes a plurality of optical polygon elements including a first polygon element 802A and a second polygon element 802B. First polygon element 802A and second polygon element 802B can each have multiple reflective surfaces (also referred to as reflective facets) configured to reflect or redirect light. The polygon elements 802A and 802B can be substantially the same or different. In one example, first polygon element 802A and second polygon element 802B can have the same number of reflective facets (e.g., both have 5 facets) or different number of reflective facets (e.g., one polygon has 5 facets and the other has 6 facets). In another example, the dimensions, tilt angles, and/or shapes of facets of first polygon element 802A and second polygon element 802B can be substantially the same or different. Dimensions of a facet include the width and height of the facet. Thus, one polygon element may have a width that is less than, substantially the same, or greater than the other polygon element; and the one polygon element may have a height that is less than, substantially the same, or greater than the other polygon element. A reflective facet can be configured to have any shape including a rectangle shape, a trapezoidal shape, a parallelogram shape, etc. The tilt angle of a reflective facet refers to the angle between the normal direction of the facet and a rotational axis of the polygon element. Thus, the reflective facets of one polygon element may have a tilt angle that is different from, or the same as, the tilt angle of the reflective facets of another polygon element. The number of facets, the dimensions of facets, the tilt angles, and/or the shapes of the reflective facets of a polygon element can affect the light directions and the FOVs that the polygon element scans (e.g., in the horizontal direction and optionally in the vertical direction).

In some embodiments, the first optical polygon element 802A and the second optical polygon element 802B can be configured substantially the same or differently such that they have one or more of the following same or different characteristics: speeds, rotational directions, numbers of the reflective surfaces, dimensions, positions and/or orientations with respect to other optical elements, shapes, and angles between adjacent reflective surfaces.

With reference still to FIG. 8, the optical core assembly 800 may also include one or more of: an optical core assembly enclosure 831, moveable reflective elements 808A and 808B, transmitting optics 804A and 804B, and receiving optics 806A and 806B. Moveable reflective elements 808A and 808B can be, for example, oscillating mirrors, galvanometer mirrors, oscillating prisms, or any other optics that are moveable to redirect light. In the configuration shown in FIG. 8, the combination of first polygon element 802A and moveable reflective element 808A forms a first light steering device 801A; and the combination of second polygon element 802B and moveable reflective element 808B forms a second light steering device 801B. While FIG. 8 illustrates that each of light steering devices 801A and 801B includes a polygon element and a moveable reflective element, it is understood that each of the light steering devices can be configured differently. For instance, first light steering device 801A may include a polygon element 802A and a moveable reflective element 808A; while second light steering device 801B may include only a polygon element 802B with no moveable reflective element 808B; and vice versa. As another example, second light steering device 801B may include only a moveable reflective element 808B (e.g., an oscillation mirror) but no polygon element; or a 1-dimensional micro-electromechanical system (MEMS) based optical element having an oscillation mirror base. Some of the alternative configurations of optical core assembly 800 are described in more detail below.

In some examples, the first light steering device 801A and second light steering device 801B are included in the same enclosure 831. Other components (e.g., transmitting optics 804A and 804B and receiving optics 806A and 806B) of the optical core assembly 800 may also be included in enclosure 831. In other examples, the other components are not included in enclosure 831, and are placed somewhere else in the moveable platform. For example, transmitting optics 804A and 804B can be optical fiber-based transmitters providing light beams to light steering devices 801A and 801B. Therefore, they can be placed anywhere inside or outside of enclosure 831. As another example, receiving optics 806A and 806B can also include optical fiber-based receivers, lens, prisms, mirrors, etc.; and they can be placed anywhere inside or outside of enclosure 831. In some examples, optical core assembly 800 may comprise two or more transceiver assemblies each comprising transmitting optics (e.g., 804A or 804B) and receiving optics (806A or 806B). The transmitting and receiving optics can be physically integrated as a transceiver assembly or physically separated as discreate components. FIG. 8 illustrates only one optical core assembly (i.e., assembly 800) that is disposed within enclosure 831. It is understood that more than one optical core assemblies may be disposed within the same enclosure (e.g., enclosure 8310 or different enclosures. An enclosure can be, for example, a housing or a structure that encloses the internal components. The enclosure may have one or more openings, windows, cutouts, etc., for the internal components to communicate to external components or environment.

One or both light steering devices 801A and 801B can be configured to scan one or more FOVs in horizontal and vertical directions. For instance, as shown in FIG. 8, light steering device 801A can scan light to a first partial FOV 820A and light steering device 801B can scan light to a second partial FOV 820B. The combination of the first and second partial FOVs 820A and 820B forms the entire FOV 820 of the LiDAR system having optical core assembly 800. In the configuration shown in FIG. 8, first optical polygon element 802A steers light at least horizontally to scan the first partial field-of-view 820A of the LiDAR scanning system; and second optical polygon element 802B is configured to steer light at least horizontally to scan the second partial field-of-view 820B of the LiDAR scanning system. If moveable reflective elements 808A and 808B are used, as shown in FIG. 8, they can be used to scan the vertical directions of the partial FOVs 820A and 820B, respectively. If one or both of moveable reflective elements 808A and 808B are not used, one or both corresponding optical polygon elements 802A and 802B may be configured to scan both horizontal and vertical directions of the partial FOVs 820A and 820B. As described in more details below, one or both of optical polygon elements 802A and 802B may be, for example, variable angle multiple facet polygon (VAMFP) mirrors to facilitate scanning in both horizontal and vertical directions.

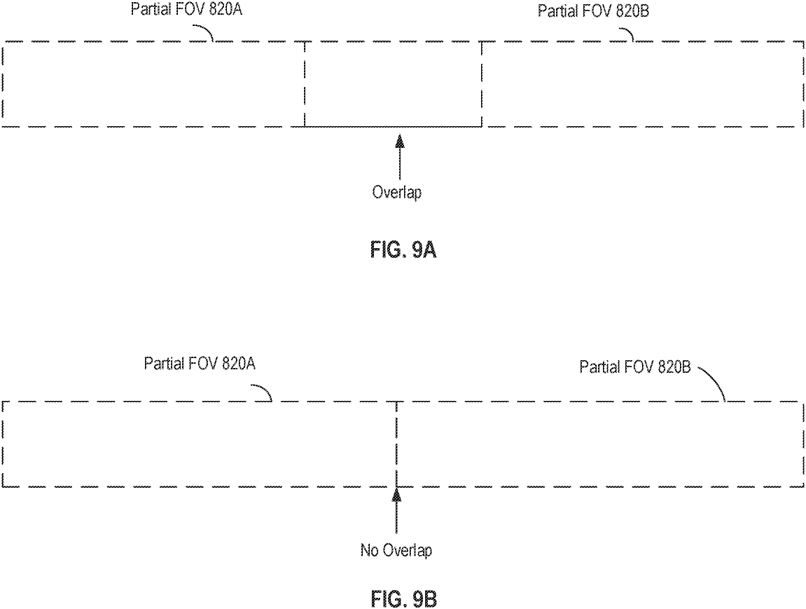

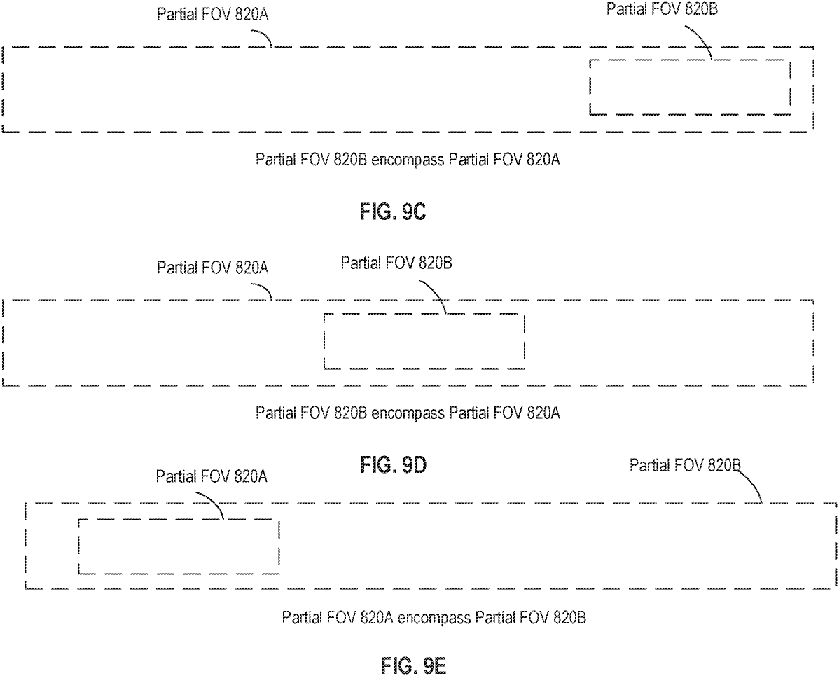

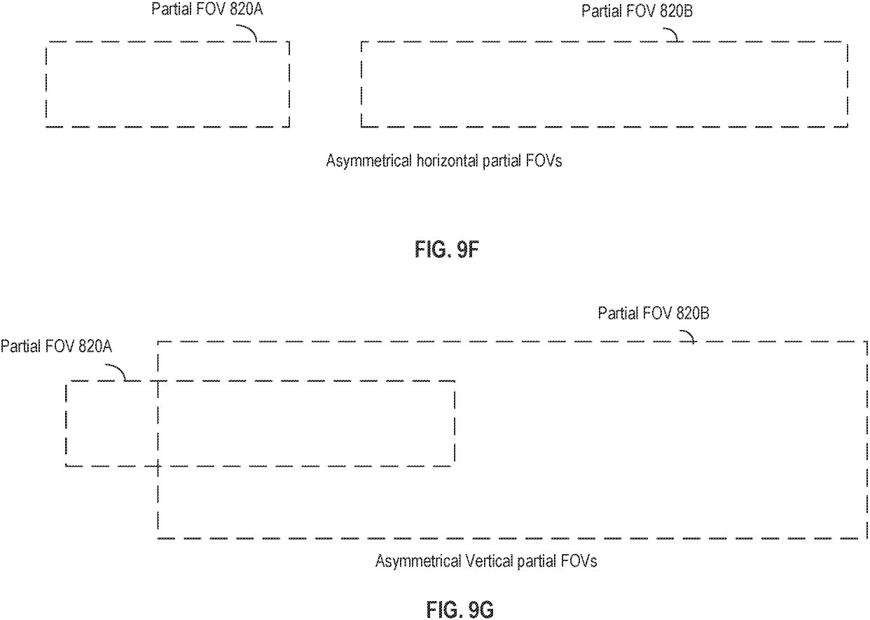

The partial FOVs 820A and 820B shown in FIG. 8 may or may not be equally distributed. FIGS. 9A-9G illustrate several embodiments of the relation between the partial FOVs 820A and 802B. With reference to FIGS. 8 and 9A-9G, the light steering devices 801A and 801B can be configured to provide any desired distribution of the partial FOVs 820A and 820B. FIG. 9A shows that partial FOV 820A can overlap with partial FOV 820B in the center area. In other words, the overlapped area shown in FIG. 9A has a higher scanning density because both light steering devices 801A and 801B are configured to scan the overlapped area. The overlapped area shown in FIG. 9A may be positioned to correspond to a region-of-interest (ROI), which generally requires a higher scanning density. In FIG. 9A, for example, each of partial FOV 820A and partial FOV 820B is about 120 degrees or more horizontally and about 30 degrees or more vertically, and the overlapping area is about 30-60 degrees horizontally, thereby providing higher scanning density in the center portion of the entire FOV. FIG. 9B illustrates that partial FOV 820A does not overlap with partial FOV 820B. The two partial FOVs are contiguous and thus the scanning of the light steering devices 801A and 801B covers the entire FOV with no gap. In FIG. 9B, each of partial FOVs 820A and 820B may be about 90 degrees or more horizontally, thereby covering 180 degrees or more in the horizontal direction for the entire FOV. And both the partial FOVs 820A and 820B may have a vertical coverage of about 30 degrees or more.

FIGS. 9C-9E illustrate different embodiments where the light steering devices 801A and 801B are configured such that one partial FOV encompasses another partial FOV. FIGS. 9C and 9D illustrate that partial FOV 820A encompasses partial FOV 820B. For instance, light steering device 801A may be configured to scan the entire FOV, while light steering device 801B may be configured to scan an ROI within the entire FOV. Thus, the ROI can have a higher scanning density. The ROI may be positioned at any part of the entire FOV. FIG. 9C illustrates that the partial FOV 820B is at the right side of the entire FOV; and FIG. 9D illustrates that the partial FOV 802 is at the center area of the entire FOV. FIGS. 9C and 9D thus illustrate that one or more ROIs can be positioned at different parts of the entire FOV as needed. As described above, because the ROI area is scanned by both light steering devices 801A and 801B, the scanning density of the ROI area is higher than a non-ROI area. In FIGS. 9C-9D, for example, partial FOV 820A is about 120 degrees or more horizontally and about 30 degrees or more vertically, and partial FOV 820B is about 30-60 degrees horizontally. As a result, the scanning performed by the combination of the light steering devices 801A and 801B provides a higher scanning density at the right side or the center area of the entire FOV.

FIG. 9E illustrates that the light steering devices 801A and 801B can be configured such that partial FOV 820B encompasses partial FOV 820A, and partial FOV 820A is positioned at the left side of the entire FOV. The partial FOVs can be configured dynamically by changing one or more characteristics of the light steering devices including, for example, the scanning speeds of the polygon elements and/or the moveable reflective elements. In FIG. 9E, for example, partial FOV 820B is about 120 degrees or more horizontally and about 30 degrees or more vertically, and partial FOV 820A is about 30-60 degrees horizontally, thereby providing higher scanning density at the left side of the entire FOV.

FIGS. 9F and 9G illustrate that the light steering devices 801A and 801B can be configured such that their scanning of the respective partial FOVs 820A and 820B are asymmetrical, overlapping, and/or non-overlapping. FIG. 9F illustrates partial FOV 820A and partial FOV 820B have different horizontal scanning ranges. For instance, the horizontal range of partial FOV 820A may be about 45 degrees and partial FOV 820B may be about 120 degrees. Therefore, the horizonal ranges of the partial FOVs 820A and 820B are asymmetrical. Similarly, as shown in FIG. 9G, the vertical ranges of partial FOVs 820A and 820B can also be asymmetrical. For instance, the vertical range of the partial FOV 820A may be 30 degrees, and the vertical range of the partial FOV 820B may be 45 degrees or more. FIG. 9F also shows that the partial FOVs 820A and 820B do not overlap; and FIG. 9G shows that they overlap with each other both horizontally and vertically. It is understood that the illustrations of FIGS. 9A-9G are not limiting, and the partial FOVs provided by different light steering devices containing a plurality of polygon elements can be configured in any desired manner, based on, for example, the scanning requirements, environmental situations (e.g., density/importance of objects surrounding the LiDAR scanning system), requests from vehicle controllers, etc.

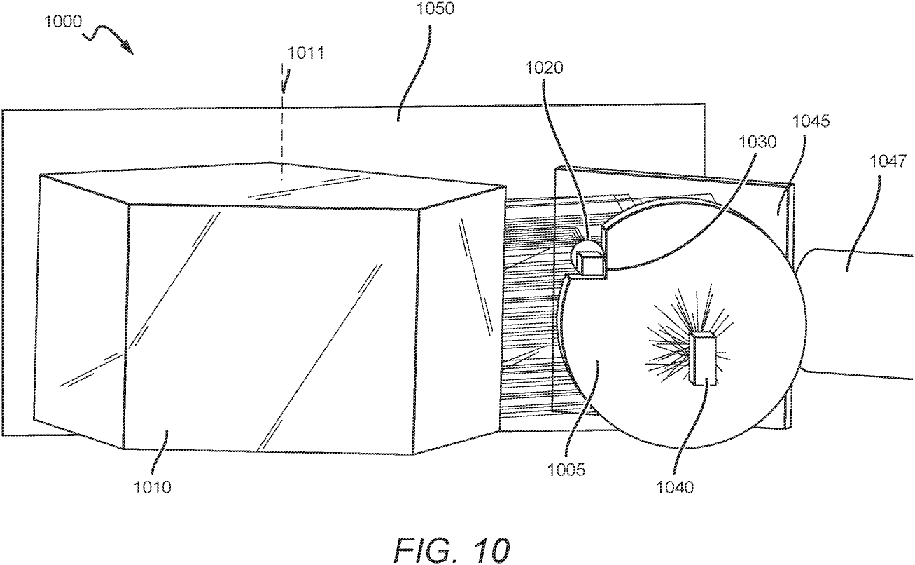

FIG. 10 is a diagram illustrating a configuration for an optical core assembly 1000 of a LiDAR scanning system according to various embodiments. Optical core assembly 1000 can be used to implement the optical core assemblies 710, 720, 730, and 800 described above. In the embodiment shown in FIG. 10, optical core assembly 1000 includes an optical polygon element 1010, transmitting optics 1020, collection lens 1005, moveable reflective element 1045, and receiving optics 1040. Similar as described above, optical polygon element 1010 and moveable reflective element 1045, in combination, can form a light steering device that steer light both horizontally and vertically to the FOV of optical core assembly 1000. For instance, optical polygon element 1010 can scan light in the horizontal direction and moveable reflective element 1045 can scan light in the vertical direction. In the example shown in FIG. 10, optical polygon element 1010 comprises a plurality of reflective surfaces, also referred to as reflective facets. Each of the reflective surfaces has an orientation substantially parallel to a rotation axle 1011 of the optical polygon element 1010. Thus, the tilt angle of a reflective surface of polygon element 101 is 90 degrees. That is, the normal direction of the reflective surface is perpendicular to rotation axle 1011. FIG. 10 illustrates that optical core assembly 1000 includes a polygon element 1010 with a 90-degree tilt angle. Thus, the light directed by the polygon element 1010 can travel to or from other optical components in a substantially horizontal direction as shown in FIG. 10. As a result, the other optical components (e.g., moveable reflective element 1045) can be disposed on the side of polygon element 1010, thereby forming a lateral arrangement of optical core assembly 1000.

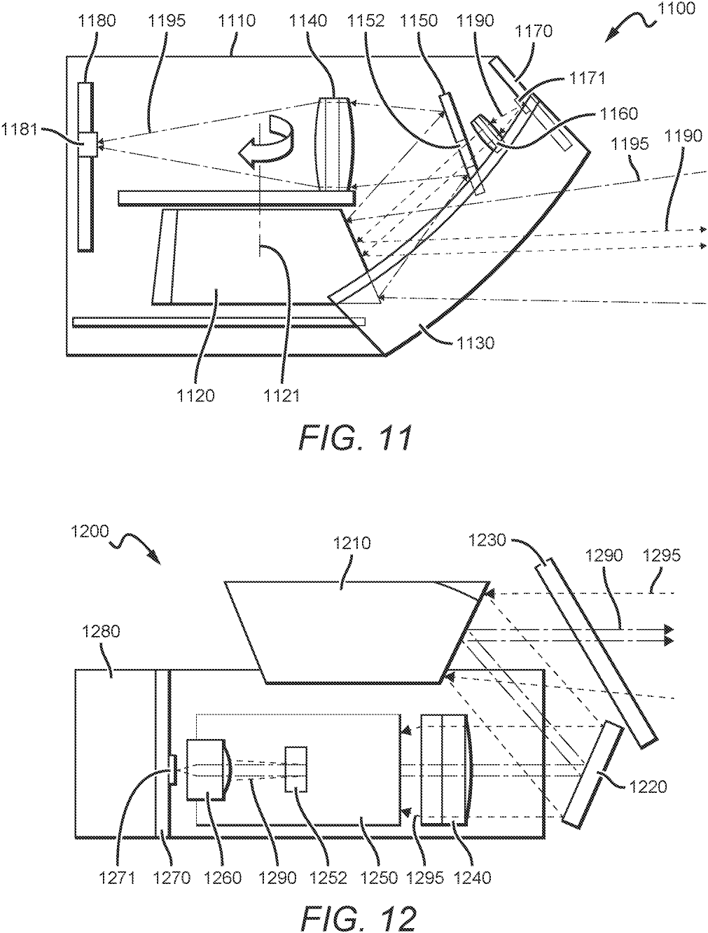

In other examples, one or more of the plurality of reflective surfaces may not be parallel to the rotation axle of the optical polygon element. That is, the normal direction of the reflective surface is not perpendicular to the rotation axle. Thus, in these example, the tilt angle of each reflective surface of the optical polygon element is not 90 degrees. The tilt angle may instead be an acute angle (e.g., if the reflective surface is tilted upward forming a tilt angle between 0-90 degrees) or an obtuse angle (e.g., if the reflective surface is tilted downward forming a tilt angle between 90-180 degrees). A polygon element having acute or obtuse tilt angles is also referred to as a wedged-shaped polygon element. Examples of wedged-shaped polygon elements are illustrated in FIGS. 11 and 12 in further details. The configurations of optical core assemblies shown in FIGS. 11 and 12 include vertically-stacked arrangements of the polygon element and other optics. The vertically-stacked arrangement is described in more detail below.

With reference back to FIG. 10, moveable reflective element 1045 can be, for example, an oscillating mirror such as a galvanometer mirror. Moveable reflective element 1045 can be operated by a motor 1047 positioned adjacent to element 1045 in a lateral manner as shown in FIG. 10. For example, the motor 1047 may be positioned laterally next to element 1045 such that it does not increase the height of optical assembly 1000. In other embodiments, optical core assembly 1000 may not include a moveable reflective element and may use just the optical polygon element 1010 to scan the FOV. As described below in more detail, such an optical polygon element 1010 may be a variable angle multiple facet polygon (VAMFP) capable of performing scanning in both horizontal and vertical directions.

With continued reference to FIG. 10, in some embodiments, optical core assembly 1000 is laterally arranged to reduce the vertical height. For instance, as shown in FIG. 10, optical polygon element 1010 and moveable reflective element 1045 are arranged side-by-side rather than being vertically stacked. In addition, the collection lens 1005 is positioned laterally with respect to optical polygon element 1010 and moveable reflective element 1045. In one embodiment, collection lens 1005 has a notch or opening 1030 configured to accommodate transmitting optics 1020. FIG. 10 illustrates that the notch or opening 1030 is located proximate to an edge or a corner (e.g., top left corner) of collection lens 1005. The notch or opening 1030 can also be located proximate to other positions (e.g., in the top middle part of the collection lens 1005, or external to collection lens 1005). The opening or notch 1030 has a dimension configured based on an optical receiving aperture requirement. If the dimension of opening or notch 1030 is too big, it may negatively affect the performance of the collection lens 1005. If it is too small, the transmitter optics 1020 (e.g., a fiber array) may not be able to fit in. For instance, the size of the opening or notch 1030 can be selected such that collection lens 1005 has an optical receiving aperture sufficient to detect a 10% reflectivity target located at 200 meters or 250 meters distance, or at a longer distance. In some embodiment, the optical receiving aperture the collection lens 1005 may be configured based on a receiving performance between 0.5 and 500 meters, inclusive. Thus, the dimensions of the collection lens 1005 and opening/notch 1030 can be selected based on the receiving aperture requirements. In some examples, collection lens 1005 is a low-profile collection lens that reduces the height of the optical core assembly 1000 while maintaining a sufficient optical receiving aperture (e.g., an aperture for detecting 10% reflectivity target at 200 m distance).

Through the notch or opening 1030, transmitting optics 1020 emit light beams toward moveable reflective element 1045. Transmitting optics 1020 may include a multiple-channel transmitter (e.g., a transmitter fiber array) that is at least partially disposed within the notch or opening 1030 to deliver light beams to moveable reflective element 1045. The size and position of the notch or opening 1030 can be configured based on the receiving performance requirements or the detection range requirements (e.g., detection of 2 m to 200 m). As described above, moveable reflective element 1045 may oscillate to facilitate scanning of the light beams in one direction (e.g., the vertical direction). The light beams are redirected by the moveable reflective element 1045 to optical polygon element 1010, which is configured to scan the light beams in another direction (e.g., the horizontal direction). The optical polygon element 1010 further scans the light beams to an FOV through window 1050.

With reference to both FIGS. 8 and 10, in some embodiments, the optical core assembly 800 or 1000 comprises one or more windows (e.g., window 1050 shown in FIG. 10) forming a portion of an exterior surface of the optical core assembly enclosure (e.g., enclosure 831 shown in FIG. 8). Light can pass through a window. In some examples shown in FIG. 10, window 1050 is substantially parallel to the rotational axle 1011 of polygon element 1010 or other optics. In other examples shown in FIGS. 11 and 12, at least one of the one or more windows (e.g., windows 1130 and 1230) is tilted at an angle configured based on at least one of an orientation of the optical polygon element or an orientation of the transmitting and receiving optics. In one embodiment, a window of an optical core assembly may include an antireflection coating.

As described above, polygon element 1010 scans light beams to an FOV to illuminate one or more objects in the FOV. The light beams are then scattered and/or reflected to form return light. The return light travels back through window 1050 and is received by optical polygon element 1010. The return light is then redirect by one or more reflective surfaces of optical polygon element 1010 to moveable reflective element 1045. In turn, moveable reflective element 1045 redirects the return light to collection lens 1005, which collects the return light and passes it to receiving optics 1040. In some embodiments, the receiving optics 1040 may include one or more receiving fiber arrays coupled to collection lens 1005. The receiving fiber arrays can deliver the return light to one or more light detectors and/or other receiving components (e.g., mirrors, prisms, fibers, ADC, APD, etc.) for detecting and processing the return light. The receiving optics 1040 can be positioned downstream from the collection lens 1005 in an optical path. For instance, when receiving optics 1040 includes one or more receiving fiber arrays, at least one of the one or more receiving fiber arrays can be located adjacent to a back side of the collection lens 1005 to receive return light collected by collection lens 1005, and deliver the return light to other components for further processing. In some embodiments, the receiving optics 1040 further comprises one or more optical detectors coupled to the receiving fiber arrays. The optical detectors can be configured to detect the return light and convert the return light to electrical signals. In some embodiments, receiving optics 1040 includes an optical detector array optically coupled to collection lens 1005 and/or one or more other collection lens (not shown in FIG. 10). Therefore, an optical detector array can be used for detecting return light collected by multiple collection lens associated with multiple light steering devices.

In the above description, the combination of polygon element 1010 and moveable reflective element 1045, when moving with respect to each other, steers light both horizontally and vertically to illuminate one or more objects in a partial FOV of the LiDAR system; and obtains return light formed based on the illumination of the one or more objects. This type of configuration thus uses the light steering device (e.g., comprising a polygon element and a moveable reflective element) for both steering light out to the FOV and directing return light to collection lens and receiving optics. This type of configuration is therefore referred to as the co-axial configuration, indicating that the transmitting light path and the receiving light path are co-axial or at least partially overlap. A co-axial configuration eliminates or reduces redundant optical components, thereby making the LiDAR system more compact and improving the efficiency and reliability of the optical core assembly.

In the lateral arrangement shown in FIG. 10, the overall height of optical core assembly 1000 depends on the maximum height of optical polygon element 1010, transmitting optics 1020, collection lens 1005, moveable reflective element 1045, and receiving optics 1040. For example, because these components are arranged laterally, the overall height of optical core assembly 1000 may be the same or substantially the same as the height of the optical polygon element 1010 (or whichever component has the maximum height). As a result, the overall height of the optical core assembly 1000 can be reduced or minimized.

Similarly, with reference back to FIG. 8, the vertical positions of the plurality of optical polygon elements 802A and 802B, the one or more movement reflective elements 808A and 808B, the transmitting optics 804A and 804B, and receiving optics 806A and 806B can be aligned to minimize an amount of protrusion of the optical core assembly 800 in the vertical direction. In other words, optical core assembly 800 can also be arranged laterally. In some examples, the height of the optical core assembly 800 is about 45 mm, about 30 mm, or less. As described above in connection with FIGS. 7A-7D, in some embodiments, an optical core assembly mounted to a moveable platform (e.g., a vehicle) may have a portion that protrudes outside of the planar surface of the roof of the moveable platform. The portion of the optical core assembly protrudes outside of the planar surface of the roof of the moveable platform protrudes in a vertical direction by an amount corresponding to a lateral arrangement of the optical core assembly. The optical core assembly includes a plurality of optical polygon elements, one or more moveable reflective elements, and the transmitting and receiving optics. Therefore, reducing the overall height of the optical core assembly can reduce the protrusion of the optical core assembly outside of the moveable platform. For instance, if the optical core assembly has a plurality of optical polygon elements, the optical polygon elements (and other components such as the moveable reflective elements) can all be arranged laterally (e.g., side-by-side), thereby reducing the overall height of the optical core assembly.

In some examples, the amount of protrusion of the optical core assembly outside of a moveable platform is determined based on vehicle aerodynamic requirements and/or the optical scanning requirements. From the vehicle aerodynamic aspect, the amount of protrusion should ideally be minimized to near zero. Nonetheless, reducing the height of the optical core assembly too much may negatively affect the optical scanning performance of the LiDAR system. Thus, the overall height of the optical core assembly, and in turn the amount of the protrusion, can be determined based on both requirements. Reducing the vertical height of the optical core assembly may expand the overall dimension in the lateral direction, because components of the optical core assembly are arranged side by side in a lateral manner, therefore expanding the lateral dimension. In general, the lateral dimension of the optical core assembly may not be limited because the moveable platform may have sufficient space in the lateral dimension. In other examples, if a space for accommodating the optical core assembly is laterally limited, the overall height of the optical core assembly may not be reduced. In general, if the optical core assembly is mounted to the roof of the moveable platform, it is at least partially integrated with a planar surface of the roof. Therefore, whether the overall height of the optical core assembly needs to be reduced depends on the integration manner (e.g., protruded outside of the roof or fully embedded), mounting positions, the aerodynamic requirements, and the optical scanning performance requirements.

With reference back to FIG. 8, to reduce the overall height of optical core assembly 800, the components can be arranged laterally similar to that of optical core assembly 1000 described above. For instance, for light steering device 801A, optical polygon element 802A and moveable reflective element 808A can be arranged side by side in a lateral manner. Light steering device 801B can be arranged similarly. And light steering devices 801A and 801B can be arranged laterally too. In some embodiments, as shown in FIG. 8, optical core assembly 800 can be arranged such that the transmitting optics 804A and 804B, the receiving optics 806A and 806B, and at least one of the one or more moveable reflective elements 808A and 808B are positioned between the plurality of optical polygon elements 802A and 802B. In other embodiments, one or more of the transmitting optics 804A and 804B, the receiving optics 806A and 806B, and at least one of the one or more moveable reflective elements 808A and 808B can be arranged in other manners (e.g., placing moveable reflective element 808A, transmitter optics 804A, receiving optics 806A at the left side of optical polygon element 802A). The selection of the arrangement of the components in optical core assembly 800 can be based on one or more of the integration manner (e.g., protruded outside of the roof or fully embedded), the aerodynamic requirements, and the optical scanning performance requirements.

Turning to FIG. 11, it is a diagram illustrating another configuration for at least a portion of an optical core assembly 1100 for a LiDAR scanning system according to various embodiments. For simplicity, FIG. 11 shows one optical polygon element 1120, one reflective element 1150, one collection lens 1140, one transmitting optic 1170, and one receiving optics 1180. It is understood that optical core assembly 1100 may include additional optical polygon elements and other additional components for transmitting, scanning, and receiving light. The configuration shown in FIG. 11 can be used, alone or combined with the configuration shown in FIG. 10, to implement optical core assembly 710, 720, 730, and 800. For simplicity, the configuration shown in FIG. 10 is referred to as the lateral arrangement of an optical core assembly and the configuration shown in FIG. 11 is referred to as a first vertically-stacked arrangement of an optical core assembly. Thus, optical core assembly 800 shown in FIG. 8 can be configured to have two lateral arrangements (e.g., both polygon elements 802A and 802B are arranged laterally with other components such as the moveable reflective elements 808A and 808B, respectively), one lateral arrangement (e.g., polygon element 802A is arranged laterally with other components such as the moveable reflective element 808A) and one first vertically-stacked arrangement (e.g., polygon element 802B is arranged vertically with the moveable reflective element 808B), or two vertically-stacked arrangements (e.g., both polygon elements 802A and 802B are arranged vertically with the moveable reflective elements 808A and 808B, respectively). It is understood that if optical core assembly 800 includes additional polygon elements (e.g., total of 3, 4, 5, etc. polygon elements), any combination of the arrangements can be implemented (e.g., all lateral arrangements, one lateral arrangement and all other first vertically-stacked arrangements, one first vertically-stacked arrangement and all other lateral arrangements, all vertical arrangements, etc.).

As described above in connection with FIGS. 7A-7D and 8, if an optical core assembly protrudes outside of the moveable platform (e.g., outside of a vehicle roof), the amount of the protrusion corresponding to a lateral arrangement of the plurality of optical polygon elements, the one or more moveable reflective elements, and the transmitting and receiving optics can generally be reduced from an amount of protrusion corresponding to a non-lateral arrangement such as a vertically-stacked arrangement shown in FIGS. 11 and 12. For instance, in a lateral arrangement of an optical core assembly, the height of the optical core assembly may have a height of 45 mm or less, while still capable of scanning a horizontal FOV of 120 degrees or more.

FIG. 11 illustrates a cross-sectional view of an optical core assembly 1100 having a first vertically-stacked configuration according to one embodiment. As shown in FIG. 11, optical core assembly 1100 includes an enclosure 1110, an optical polygon element 1120, a collection lens 1140, a reflective element 1150, a collimation lens 1160, transmitting optics 1170, and receiving optics 1180. In some embodiments, transmitting optics 1170 includes a laser circuit board. A laser source 1171 disposed on the laser circuit board generates one or more channels of outgoing laser light, in the form of multiple light beams. The light beams are directed to collimation lens 1160 to collimate the outgoing light beams. One of the outgoing light beams is depicted as light beam 1190. Reflective element 1150 can be a moveable reflective element (e.g., an oscillating mirror) or fixed reflective element (e.g., a combining mirror). In one embodiment, reflective element 1150 may have one or more openings 1152. Openings 1152 allows outgoing light beam 1190 to pass through the reflective element 1150. Openings 1152 can include one or more cutouts from reflective element 1150. In other embodiments, openings 1152 can be a lens, an optics having anti-reflective coating, or anything that allows the outgoing light beam 1190 to pass.

In some embodiments, reflective element 1150 can also direct return light (e.g., light 1195) passed by polygon element 1120. Return light is formed in an FOV and received by polygon element 1120 through window 1130. Reflective surfaces of polygon element 1120 redirect return light to reflective element 1150. The reflective surface of reflective element 1150 (on the opposite side of laser source 1171) redirects the return light 1195 to light detector 1181 on receiving optics 1180 (e.g., a detector circuit board). In one embodiment, opening 1152 is located in the center of reflective element 1150. In other embodiments, opening 1152 can be located in other parts of reflective element 1150 that is not the center. In yet other embodiments, the opening of a reflective element 1150 is configured to pass the collected return light to a light detector, and the remaining portion of the reflective element 1150 is configured to redirect the plurality of light beams from the laser source.

Still referring to FIG. 11, in one embodiment, the collimated light beams (e.g., beams 1190) are directed through opening 1152 of reflective element 1150 toward polygon element 1120. In other embodiments, outgoing light beams from laser source 1171 may be redirected by one or more interim reflective mirrors (not shown) before they reach polygon element 1120. In some embodiments, polygon element 1120 may have a plurality of reflective surfaces. For example, polygon element 1120 may have 3, 4, 5, 6, etc. reflective surfaces. At any given time, polygon element 1120 rotates about a rotational axis 1121; and outgoing light beams are reflected by a reflective surface of polygon element 1120. When polygon element 1120 rotates, each of the plurality of reflective surfaces reflects outgoing light beams in turn and directs them through window 1130 to illuminate the field-of-view.

If there are objects in the field-of-view, return light is formed (e.g., scattered or reflected) by the objects and is directed back through window 1130 to a facet of polygon element 1120. One such return light is depicted as 1195. As described above, return light is directed by the polygon element 1120 toward the reflective surface of reflective element 1150. The return light may travel directly or indirectly (e.g., via a folding mirror) to reflective element 1150. Reflective element 1150 then directs the return light to collection lens 1140, which focuses return light to a small spot size. Then, return light is directed to and is detected by a detector array 1181 included in the receiving optics 1180 (e.g., a detector circuit board).

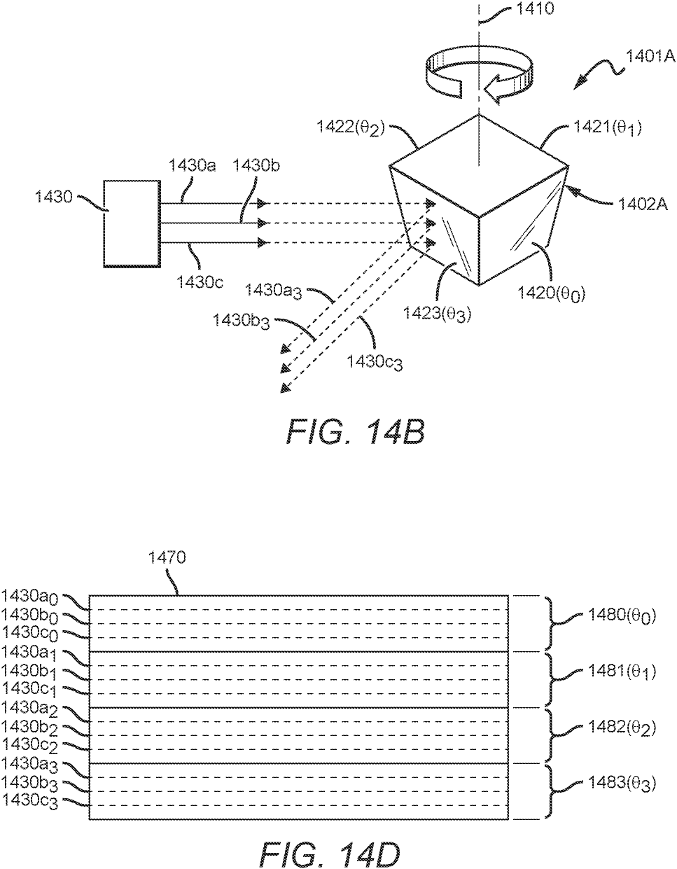

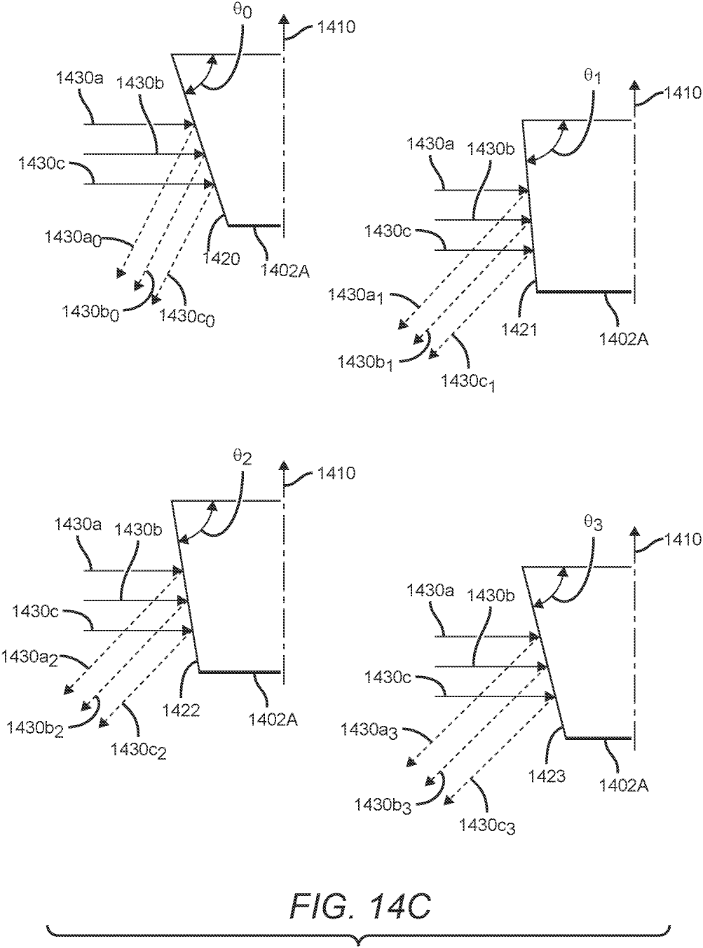

In some embodiments, multi-facet polygon element 1120 can have reflective surfaces that are the same or substantially the same. For example, the reflective surfaces may each have substantively the same tilt angle. A tilt angle is the angle between a normal direction of a reflective surface and the rotational axis of the polygon element. In some other embodiments, polygon element 1120 is a variable angle multi-facet polygon (VAMFP), which has different tilt angles for different reflective surfaces. If polygon element 1120 is a VAMFP, the reflective element 1150 may not be needed, or may be a fixed mirror, because a VAMFP can be configured to scan both horizontal and vertical directions of the FOV. FIG. 14B illustrates a perspective view of a VAMFP according to one embodiment. A VAMFP is described in more detail below in FIGS. 14B-14D. VAMFP is also described in more detail in U.S. Non-Provisional Pat. Application No. 16/837,429, filed on Apr. 1, 2020, entitled “Variable Angle Polygon For Use With A Lidar System”, the content of which is incorporated by reference in it is entirety for all purposes.

In the configuration shown in FIG. 11, the polygon element 1120 is positioned at the lower portion of optical core assembly 1100. The reflective element 1150, the collection lens 1140, and other components are positioned at the upper portion of optical core assembly 1100. Thus, the optical core assembly 1100 has a vertically-stacked arrangement of the components. This vertically-stacked arrangement is referred to as the first vertically-stacked arrangement or vertically-stacked arrangement with a lower-positioned polygon. The vertically-stacked arrangement can save space and make the entire optical core assembly more compact. However, an optical core assembly having the first vertically-stacked arrangement may have a vertical height that is greater than the vertical height of an optical core assembly having a lateral arrangement. The first vertically-stacked arrangement of the optical core assembly may be used in places where the vertical height is not a limitation or is of a less concern, or in places where the assembly needs to more compact (e.g., at a vehicle corner, rear-view mirror, or other small spaces).

FIG. 12 is a diagram illustrating another configuration for an optical core assembly 1200 of a LiDAR scanning system according to various embodiments. For simplicity, FIG. 12 shows one optical polygon element 1210, one reflective element 1220, one collection lens 1240, one transmitting optic 1270, and one receiving optics 1280. It is understood that optical core assembly 1200 may include additional optical polygon elements and additional other components for transmitting, scanning, and receiving light. The configuration shown in FIG. 12 can be used, alone or combined with the configuration shown in FIGS. 10 and 11, to implement optical core assemblies 710, 720, 730, and 800. As described above, the configuration shown in FIG. 10 is referred to as the lateral arrangement and the configuration shown in FIG. 11 is referred to as the first vertically-stacked arrangement or vertically-stacked arrangement with a lower-positioned polygon. The configuration shown in FIG. 12 is referred to as a second vertically-stacked arrangement or a vertically-stacked arrangement with an upper-positioned polygon. Thus, optical core assembly 800 shown in FIG. 8 can be configured to have two lateral arrangements (e.g., both polygon elements 802A and 802B are arranged laterally with other components such as the moveable reflective elements 808A and 808B, respectively), one lateral arrangement (e.g., polygon element 802A is arranged laterally with other components such as the moveable reflective element 808A) and one first or second vertically-stacked arrangement (e.g., polygon element 802B is arranged vertically with the moveable reflective element 808B), or two first and/or second vertically-stacked arrangements (e.g., both polygon elements 802A and 802B are arranged vertically with the moveable reflective elements 808A and 808B, respectively). It is understood that if optical core assembly 800 includes additional polygon elements (e.g., total of 3, 4, 5, etc. polygon elements), any combination of the arrangements can be implemented (e.g., all lateral arrangements, one lateral arrangement and all other first/second vertically-stacked arrangements, one first/second vertically-stacked arrangement and all other lateral arrangements, all first/second vertically-stacked arrangements, etc.).

FIG. 12 illustrates a cross-section view of an optical core assembly 1200 according to one embodiment. As shown in FIG. 12, optical core assembly 1200 includes polygon element 1210, reflective element 1220, collection lens 1240, combining mirror 1250, collimation lens 1260, transmitting optics 1270 (e.g., a laser circuit board), and receiving optics 1280 (e.g., a detector circuit board). Referring to FIG. 12, in some embodiments, a laser source 1271 disposed on the transmitting optics 1270 (e.g., a laser circuit board) generates one or more channels of outgoing laser light, in the form of multiple light beams. The light beams are directed to collimation lens 1260 to collimate the outgoing light beams. One of the outgoing light beams is depicted as light beam 1290. Combining mirror 1250 has one or more openings 1252. Opening 1252 allows outgoing light beam 1290 to pass through the combining mirror 1250. The reflective surface of combining mirror 1250 (on the opposite side of laser source 1271) redirects the return light (e.g., light 1295) to a light detector disposed on receiving optics 1280 including a detector circuit board. In one embodiment, opening 1252 is located in the center of combining mirror 1250. In other embodiments, opening 1252 can be located in other parts of combining mirror 1250 that is not the center. In yet other embodiments, the opening of a combining mirror is configured to pass the collected return light to a light detector, and the remaining portion of the combining mirror is configured to redirect the plurality of light beams from the laser source.

With reference still to FIG. 12, the collimated light beams 1290 are directed through opening 1252 of combining mirror 1250, and then to reflective element 1220. Reflective element 1220 can be a moveable mirror (e.g., an oscillating mirror) or a fixed mirror (e.g., a folding mirror). In one embodiment, reflective element 1220 can be a galvanometer mirror configured to oscillate about an axis to scan light along one direction (e.g., the vertical direction) of the FOV. In one embodiment, reflective element 1220 is a fixed mirror. Reflective element 1220, whether it is a moveable mirror or a fixed mirror, can be configured to redirect outgoing light beams to polygon element 1210, which is positioned above collection lens 1240 and combining mirror 1250 in the vertical direction (e.g., the direction that is perpendicular to the road surface). Polygon element 1210 may have a plurality of reflective surfaces. For example, polygon element 1210 may have 3, 4, 5, 6, 7, etc. reflective surfaces. Outgoing light beams are reflected by reflective surfaces of the polygon element 1210 and are directed through window 1230 to illuminate the field-of-view. In some embodiments, the polygon element 1210 is configured to scan light along one direction of the FOV (e.g., the horizontal direction).

If there are objects in the field-of-view, the outgoing light beams 1290 are scattered by the objects to form return light 1295, which is directed back through window 1230 to a reflective surface of polygon element 1210. Then, return light 1295 is redirected by polygon element 1210 toward reflective element 1220, which directs the return light 1295 to collection lens 1240. Referring to FIG. 12, collection lens 1240 can focus return light 1295 to a small spot size. Then, return light 1295 is reflected by combining mirror 1250 by about 90° to receiving optics 1280 including a detector circuit board disposed on the side of the optical core assembly 1200. In other embodiments, the combining mirror 1250 may not be needed, the receiving optics 1280 is disposed at the backside of the optical core assembly 1200 such that the return light 1295 can be directly passed to a detector located on the receiving optics 1280. Return light 1295 can be detected by a detector or detector array (not shown) disposed on the detector circuit board.

In some embodiments, multi-facet polygon element 1210 can have reflective surfaces that are the same or substantially the same. For example, the reflective surfaces may each have substantively the same tilt angle. In some embodiments, similar to polygon element 1120 described above, multi-facet polygon element 1210 can be a variable angle multi-facet polygon (VAMFP). For example, the reflective surfaces of polygon element 1210 may each have a different tilt angle. If polygon element 1210 is a VAMFP, the reflective element 1220 can be a fixed mirror, because a VAMFP can be configured to scan both horizontal and vertical directions of the FOV. FIG. 14B illustrates a perspective view of a variable angle multi-facet polygon according to one embodiment. A VAMFP is described in more detail below in FIG. 14B. VAMFP is also described in more detail in U.S. Non-Provisional Pat. Application No. 16/837,429, filed on Apr. 1, 2020, entitled “Variable Angle Polygon For Use With A Lidar System”, the content of which is incorporated by reference in it is entirety for all purposes.

The polygon elements 1120 and 1210 shown in FIGS. 11 and 12 are wedged-shaped polygon elements. As described above, a wedged-shaped polygon element has tilt angles that are not 90 degrees. A tile angle is the angle between the normal direction of a reflective surface and the rotational axis of the polygon element. As shown in FIG. 11, reflective surfaces of polygon element 1120 have tilt angles that are acute angles, indicating that the reflective surfaces are tilted upward. In FIG. 12, reflective surfaces of polygon element 1210 have tilt angles that are obtuse angles, indicating that the reflective surfaces are tilted downward. The tilt angles of the wedge-shaped polygon elements can be customized based on the positions of the polygon elements, the scanning requirements, and optical path configurations.

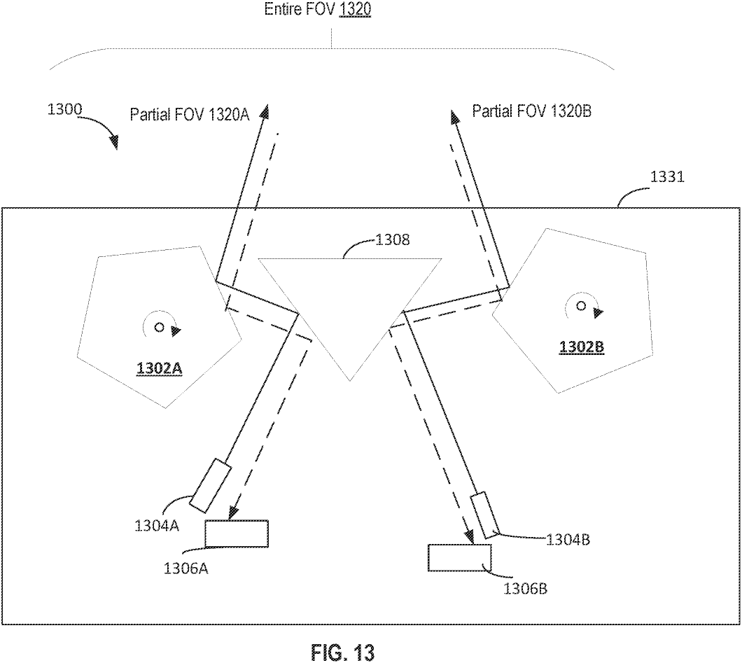

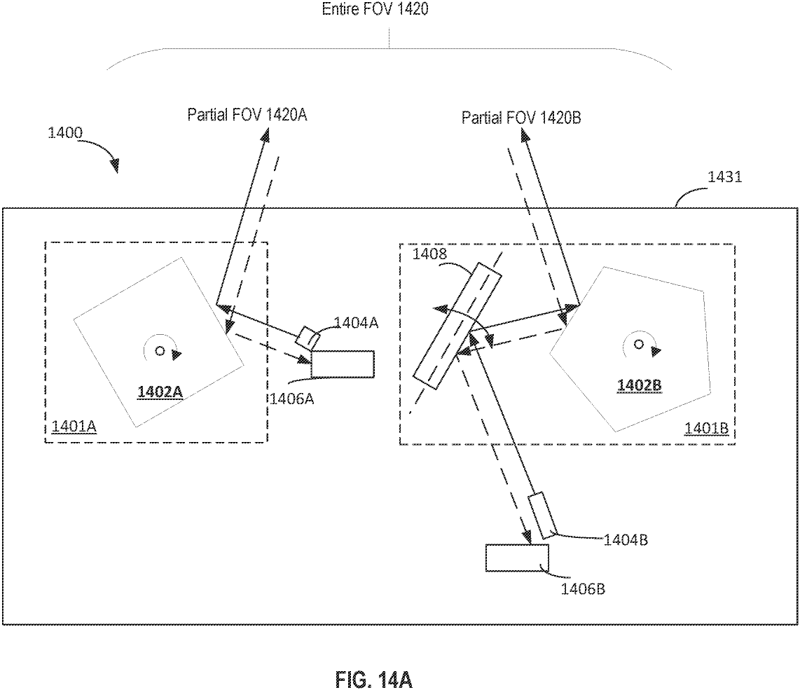

With reference back to FIG. 8, each of the light steering devices 801A and 801B has a moveable reflective element 808A and 808B, respectively. FIG. 13 is a block diagram illustrating another example of an optical core assembly 1300 having a moveable reflective element shared by multiple polygon elements, according to some embodiments. As shown in FIG. 13, optical core assembly 1300 can be used to implement optical core assemblies 710, 720, and 730 described above. Further, one or more configurations of optical core assembly 1000, 1100, and 1200, alone or in combination, can be used to implement optical core assembly 1300. In some embodiments, optical core assembly 1300 is optically coupled to one or more light sources (not shown in FIG. 13). Optical core assembly 1300 includes a first polygon element 1302A, a second polygon element 1302B, a moveable reflective element 1308, transmitting optics 1304A and 1304B, and receiving optics 1306A and 1306B. First polygon element 1302A, second polygon element 1302B, transmitting optics 1304A and 1304B, and receiving optics 1306A and 1306B can be substantially the same as first polygon element 802A, second polygon element 802B, transmitting optics 804A and 804B, and receiving optics 806A and 806B, respectively, as described above, and are thus not repeatedly described.

In the embodiment shown in FIG. 13, moveable reflective element 1308 can be an oscillation mirror or a prism configured to scan light in one direction (e.g., the vertical direction) of the FOV. For example, moveable reflective element 1308 can oscillate about an axis that is parallel to the paper surface of FIG. 13 to scan light beams along the vertical direction (e.g., the direction that is perpendicular to a road surface) of the FOV. Polygon elements 1302A and 1302B can be configured to scan light along the horizontal direction of the FOV (e.g., the direction that is parallel to the road surface). Thus, the combination of the polygon elements 1302A and 1302B, and moveable reflective element 1308 can be used to scan light in both horizontal and vertical directions to the FOV 1320.

Similar to those described above, polygon element 1302A and the moveable reflective element 1308 form a first light steering device to scan light to the partial FOV 1320A; and polygon element 1302B and the moveable reflective element 1308 form a second light steering device to scan light to the partial FOV 1320B. The partial FOVs 1320A and 1320B, in combination, form the entire FOV 1320. Optical core assembly 1300 can be configured in any manner such that partial FOVs 1320A and 1320B have relations substantially similar to the relations of partial FOVs 820A and 820B illustrated in FIGS. 9A-9G. Thus, the one or more dimensions of the partial FOVs 1320A and 1320B can be the same or different.

In the configuration shown in FIG. 13, the polygon element 1302A, polygon element 1302B, and moveable reflective element 1308 can each be controlled independently. For example, similar to those described above in connection with optical core assembly 800, one or more characteristics of the polygon elements 1302A and 1302B of optical core assembly 1300 can be controlled independently. These characteristics includes, rotational speeds, rotational directions, number of reflective surfaces, dimensions of the polygon elements, positions and/or orientations with respect to other optical elements, shapes, angles between adjacent reflective surfaces, tilt angles of the reflective surfaces, etc. Furthermore, characteristics of the moveable reflective element 1308 can also be controlled independently according to the scanning requirements. These characteristics may include rotation/oscillation speeds, trajectory, dimensions of the moveable reflective element 1308, shapes, number of reflective surfaces, refractive indices or other optical characteristics, etc.

In other embodiments, polygon element 1302A, polygon element 1302B, and moveable reflective element 1308 can be controlled in a synchronized manner. For instance, moveable reflective element 1308 is shared between the polygon elements 1302A and 1302B such that at any given time, one reflective surface of element 1308 faces polygon element 1302A to direct light to/from polygon element 1302A, and another reflective surface of element 1308 faces polygon element 1302B to direct light to/from polygon element 1302B. The characteristics of the moveable reflective element 1308 can also be controlled to synchronize with polygon elements 1302A and 1302B. In some examples, polygon elements 1302A and 1302B are synchronized such that they are phase locked during operation. The phase-locked polygon elements 1302A and 1302B can facilitate generating scanlines that have a predetermine pattern or relation, thereby simplifying the downstream process for combining the scanlines generated by the multiple polygon elements to form a synthesized point cloud. In other examples, polygon elements 1302A and 1302B may have randomly different phases. It is understood that the shared moveable reflective element 1308 can be controlled in any manner based on the scanning requirements of optical core assembly 1300.

In some embodiments, the polygon elements 1302A-1302B and moveable reflective element 1308 can be configured in a lateral arrangement. The lateral arrangement can be similar to those described above in connection with FIGS. 8 and 10. For instance, the polygon elements 1302A and 1302B and moveable reflective element 1308 can be disposed side by side so that the overall vertical height of optical core assembly 1300 can be reduced or minimized. In one example, the optical core assembly 1300 has a vertical height of 45 mm or less. The moveable reflective element 1308, the transmitting optics 1304A and 1304B, and receiving optics 1306A and 1306B can be disposed laterally between polygon elements 1302A and 1302B. The distance from polygon element 1302A to moveable reflective element 1308 and the distance from polygon element 1302B to moveable reflective element 1308 may or may not be the same. The relative positions and orientations of the polygon elements 1302A and 1302B and the moveable reflective element 1308 can be configured according to, for example, the scanning requirements of the partial FOVs 1320A and 1320B. In one embodiment, optical core assembly 1300 can be configured to scan the entire FOV 1320 in a horizontal direction greater than 120 degrees and in a vertical directions greater than 30 degrees. In one embodiment, each one of partial FOV 1320A and 1320B can be configured to be greater than 120 degrees in the horizontal direction and 30 degrees in the vertical direction.

FIG. 14A is a block diagram illustrating another example of an optical core assembly 1400 of a LiDAR scanning system having multiple polygon elements, according to some embodiments. As shown in FIG. 14A, optical core assembly 1400 can be used to implement optical core assemblies 710, 720, and 730 described above. Further, one or more configurations of optical core assembly 1000, 1100, and 1200, alone or in combination, can be used to implement optical core assembly 1400. In some embodiments, optical core assembly 1400 is optically coupled to one or more light sources (not shown in FIG. 14A). Optical core assembly 1400 includes a first polygon element 1402A, a second polygon element 1402B, a moveable reflective element 1408, transmitting optics 1404A and 1404B, and receiving optics 1406A and 1406B. Second polygon element 1402B, transmitting optics 1404A and 1404B, and receiving optics 1406A and 1406B can be substantially the same as second polygon element 802B, transmitting optics 804A and 804B, and receiving optics 806A and 806B, respectively, as described above, and are thus not repeatedly described.

In the embodiment shown in FIG. 14A, polygon element 1402A forms a light steering device 1401A without using a moveable reflective element. Polygon element 1402B and moveable reflective element 1408 form a light steering device 1401B. Both light steering devices 1401A and 1401B can be configured to scan light horizontally and/or vertically to their respective partial FOVs 1420A and 1420B. For instance, polygon element 1402A can be a variable angle multi-facet polygon mirror (VAMFP) that is configured to scan both vertically and horizontally. FIG. 14B is a diagram illustrating a perspective view of a variable angle multi-facet polygon mirror used to implement polygon element 1402A in FIG. 14A. FIG. 14C illustrates side views of each reflective surface of the polygon element 1402A used in the example optical core assembly 1400 of a LiDAR system in FIG. 14A. FIG. 14D illustrates a LiDAR system FOV with a combined bands from the plurality of reflective surfaces of a VAMFP according to one embodiment.

As shown in FIG. 14B, polygon element 1402A rotates about an axis 1410. The description below of polygon element 1402A illustrates the operation of a VAMFP assuming polygon element 1402A has four reflective surfaces. It is understood that the same principle can be applied to polygon elements having other numbers of reflective surfaces (e.g., 5, 6, 7, etc.). FIG. 14B shows that polygon element 1402A can include four reflective surfaces (or simply facets). As discussed herein, each facet may be referred to by its index, namely, facets 0, 1, 2 and 3, or may be referred to by its reference numbers, namely, facet 1420, 1421, 1422 and 1423, respectively. Transmitting optics 1430, which is similar to transmitting optics 1404A in FIG. 14A, generates multiple light beams 1430a-1430c. Through a collimation lens or lens group (not shown in the figure), light beams 1430a-1430c are directed toward one of the four facets of polygon element 1402A. As polygon element 1402A rotates about axis 1410, light beams 1430a-1430c from transmitting optics 1430 interface with each of facets 1420, 1421, 1422 and 1423 in repeated succession. The light beams redirected by each facet are depicted as beams 1430a′ₓ, with x being the index number of the facet reflecting the light beams. For example, as illustrated in FIG. 14B, individual light beams 1430a-1430c redirected by facet 3 (or facet 1423) are depicted as 1430a₃, 1430b₃, and 1430c₃. As illustrated in FIG. 14C, light beams redirected by facet 0 (or facet 1420) are depicted as 1430a₀, 1430b₀ and 1430c₀.

FIG. 14C illustrates side views of facet 1420 (the top-left sub-figure), facet 1421 (the top-right sub-figure), facet 1422 (the bottom-left sub-figure) and facet 1423 (the bottom right sub-figure). In one embodiment, each of facets 1420, 1421, 1422 and 1423 has its own unique facet angle, shown as θ₀-θ₃, respectively. The facet angle of a facet represents the angle between the facet surface and the top planar surface of polygon element 1402A. Facet 1420 corresponds with facet angle θ₀, facet 1421 corresponds with facet angle θ₁, facet 1422 corresponds with facet angle θ₂, and facet 1423 corresponds with facet angle θ₃. In one embodiment, facet angles of a polygon element (e.g., element 1010 in FIG. 10) are all 90 degrees. In other embodiments, such as the one shown in FIGS. 14A and 14B, facet angles of each facet of polygon element 1402A are less than 90 degrees, thereby forming wedge-shaped facets. In one example, a cross-section of polygon element 1402A may have a trapezoidal shape. FIG. 14C shows individual beams 1430a-1430c are being redirected by different facets 1420-1423.

In some embodiments, the facet angle of each facet corresponds to a vertical range of scanning. The vertical range of scanning of at least one facet is different from the vertical ranges of other facets. FIG. 14D shows an illustrative LiDAR system FOV 1470 (e.g., corresponding to partial FOV 1420A shown in FIG. 14A) with four non-overlapping bands 1480-1483 in the FOV, each corresponding to the individual FOV produced by one of facets 1420-1423 and their respective facet angles θ₀-θ₃. FOV 1470 also shows redirected light beams 1430a₀-1430c₀, 1430a₁-1430c₁, 1430a₂-1430c₂ and 1430a₃-1430c₃ in respective bands 1480-1483. Each of bands 1480-1483 spans the entire horizontal range of FOV 1470 and occupies a subset of the vertical range of FOV 1470. Facet angles θ₀-θ₃ may be selected such that bands 1480-1483 cover the entire vertical FOV range of a LiDAR system and are contiguous in their adjacency relationships. In other embodiments, the bands can be non-contiguous and leave gaps in-between bands. In other embodiments, two or more bands may overlap with each other vertically and/or horizontally.

With reference to FIGS. 14B and 14C, the facet angles of different facets may be different from one another. The difference of facet angles of facets can be a constant or a variable. In some embodiments, the facet angles are 2.5 to 5 degrees apart, so that the total vertical range of scanning is about 20 to 40 degrees. For example, in one embodiment, facet angles are 4 degrees apart: θ₀ is 60°, θ₁ is 64°, θ₂ is 78°, and θ₃ is 72°. In other embodiments, facet angels are 9 degrees apart, resulting in a total vertical range of scanning to be about 72 degrees. It should be understood that the use of four facets in polygon element 1402A and a three-beam light beams in FIGS. 14B-14D are merely illustrative. A VAMFP may have any number of facets and any number of light beams may be used.

With reference back to FIG. 14A, light steering device 1401B includes a polygon element 1402B and a moveable reflective element 1408. Light steering device 1401B can be substantially the same as light steering device 801B shown in FIG. 8, and is thus not repeatedly described. It is understood that FIG. 14A illustrates one embodiment of an optical core assembly 1400. Other embodiments can also be configured. For example, light steering device 1401B may not have moveable reflective element 1408 and may also include only a polygon element 1402B (e.g., another VAMFP).

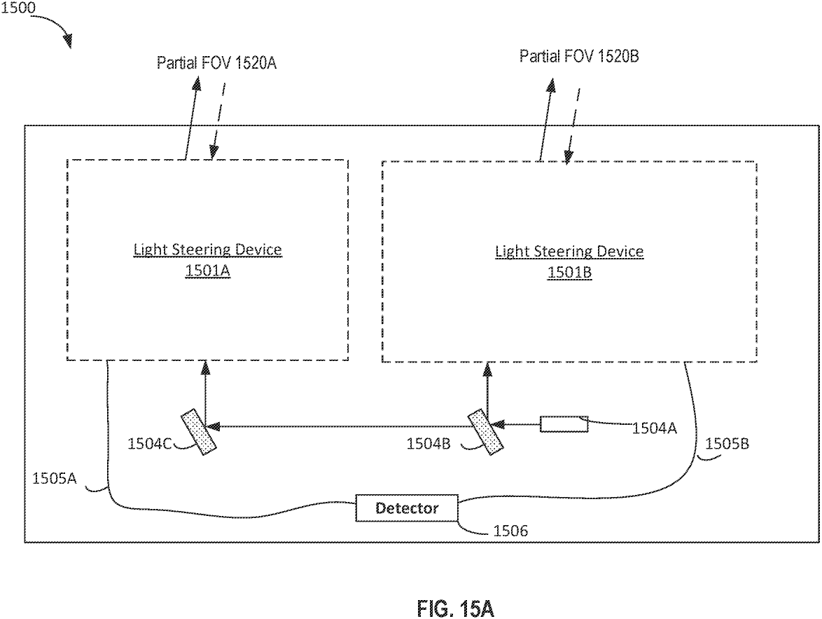

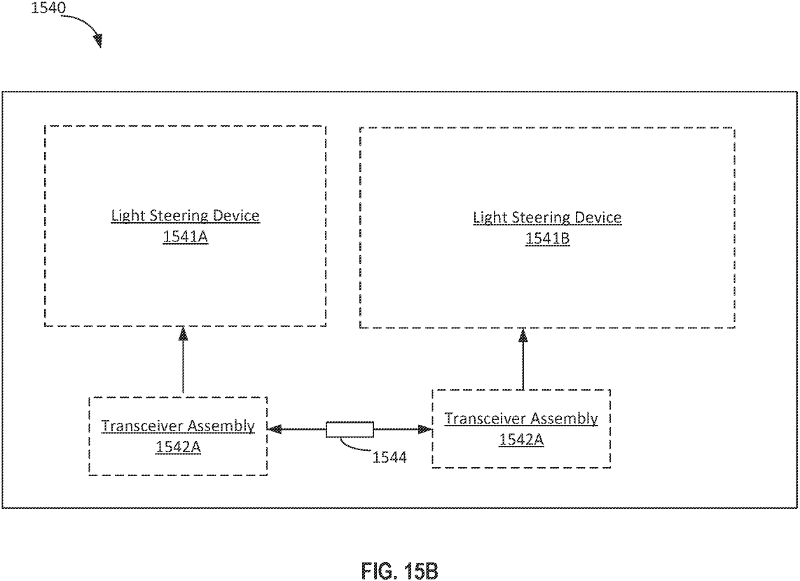

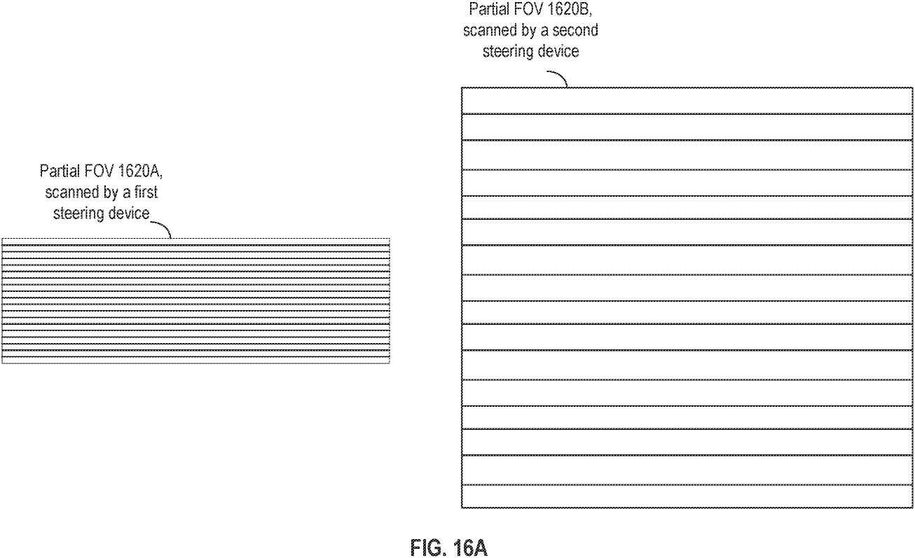

FIGS. 8, 13, and 14 illustrate different configurations of optical core assemblies 800, 1300, and 1400. It is further understood that other embodiments of the optical core assemblies can also be implemented. FIG. 15A illustrates another example optical core assembly 1500 including multiple light steering devices (e.g., two devices 1501A and 1501B) and transmitting and receiving optics, according to some embodiments. Light steering devices 1501A and 1501B can be implemented using any of the light steering devices described above (e.g., device 801A and 801B, 1401A and 1401B). Optical core assembly 1500 includes multiple polygon elements forming multiple light steering devices. Each of light steering devices 1501A and 1501B includes at least one polygon element and optionally other optics such as moveable reflective elements.

Using two light steering devices as an example, in FIG. 15A, light steering device 1501A and light steering device 1501B can be controlled independently from each other. For instance, each polygon element in light steering devices 1501A and 1501B can be controlled independently to have different rotational speeds, phases, angular positions, etc., similar to those described above.

In FIG. 15A, light steering devices 1501A and 1501B can share one or more light sources such as light source 1504A. For instance, light source 1504A comprises a laser circuit board that emits one or more outgoing light beams. The outgoing light beams are directed to transmitting optics 1504B and 1504C. Transmitting optics 1504B and 1504C can be free-space optics and/or optical fibers. For example, optics 1504B may include a partial reflection mirror that reflects a portion of the outgoing light beams received from light source 1504A to light steering device 1501B, and pass another portion of the outgoing light beams to optics 1504C. Optics 1504C can be a mirror reflecting the received light beams to light steering device 1501A. In another example, optics 1504B and 1504C comprise optical fiber arrays that deliver the light beams generated by light source 1504A to light steering devices 1501B and 1501C. As described above, a light steering device may include a polygon element and a moveable reflective element. Therefore, in one example, the optical fiber arrays include transmitter fiber arrays that deliver light beams to the moveable reflective element of a light steering device, which then redirect the light beams to a polygon element.

FIG. 15A illustrates that light steering devices 1501A and 1501B share one light source 1504A. In other embodiments, light steering devices 1501A and 1501B can have separate respective light sources. For example, light steering devices 1501A and 1501B may each have a light source. Each light source may provide one or more light beams to a respective light steering device. In some examples, the two light sources for providing light to light steering devices 1501A and 1501B can share optic components including a pump laser, an optical amplifier, an optical combiner, a wavelength divisional multiplexer, and an optical signal path. In other examples, the two light sources have separate and independent optical components. Regardless of whether light steering devices 1501A and 1501B received light from the same light source or different light sources, they may scan light having different wavelengths. If there are multiple light sources, they can be configured to generate light having different wavelengths. For example, the light provided to light steering device 1501A may include one or more first light beams having a 1550 nm wavelength; and the light provided to light steering device 1501B may include one or more second light beams having a 1535 nm wavelength. Therefore, light scanned by light steering device 1501A and light scanned by light steering device 1501B may have different wavelengths such that crosstalk between the two light steering devices are reduces or eliminated. If there is one light source, the light generated by the light source can be transmitted to light steering device 1501A. The wavelength of the light may be changed before the light goes to light steering device 1501B. The wavelength of the light may be changed by, for example, wavelength tuning, multiplication, filtering, refraction, etc.

FIG. 15A also illustrates that light steering devices 1501A and 1501B at least partially share the transmitting optics 1504B and 1504C. In other embodiments, light steering devices 1501A and 1501B may not share transmitting optics and may receive light from separate transmitting optics. FIG. 15 also illustrates that light steering devices 1501A and 1501B share a detector 1506 and/or other receiving optics (e.g., lens, mirrors, fiber arrays), which are not shown in FIG. 15A. In the example shown in FIG. 15, light steering devices 1501A and 1501B can each direct return light received from partial FOVs 1520A and 1520B, respectively, to detector 1506 via optical fiber 1505A and 1505B, respectively. In other embodiments, light steering devices 1501A and 1501B do not share any receiving optics and send return light received from their respective partial FOVs via separate and distinct receiving optics.

FIG. 15B illustrates another embodiment of an optical core assembly 1540, which includes light steering devices 1541A and 1541B, and two corresponding transceiver assemblies 1542A and 1542B. Each transceiver assembly 1542A or 1542B includes transmitting optics and receiving optics similar to those described above. The transmitting optics and receiving optics can be integrated together to form a transceiver assembly. In one embodiment shown in FIG. 15B, both the transceiver assemblies 1542A and 1542B are optically coupled to a single light source 1544. In other examples, each of transceiver assemblies 1542A and 1542B is optically coupled to a respective light source (not shown in FIG. 15B).

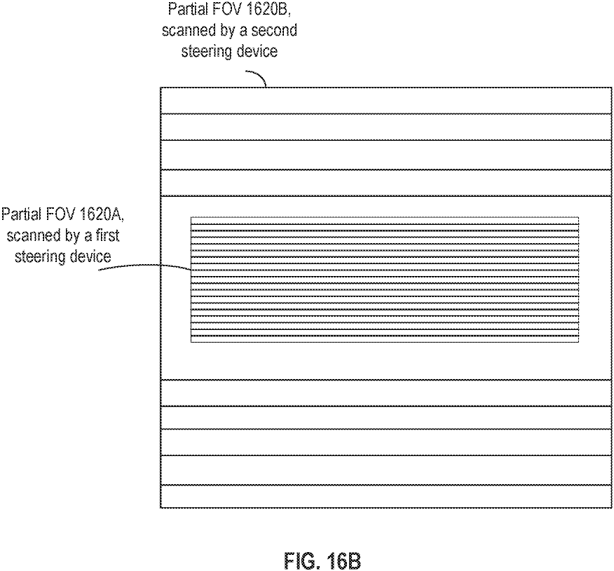

FIGS. 16A and 16B illustrate scanline patterns obtainable based on scanning of FOVs by using multiple light steering devices in an optical core assembly of a LiDAR scanning system, according to some embodiments. The multiple light steering devices can be implemented by using any of the light steering devices in an optical core assembly described above. As shown in FIG. 16A, a first light steering device is configured to scan a first partial FOV 1620A at a first scanning density; and a second light steering device is configured to scan a second partial FOV 1620B at a second scanning density. The first scanning density may be substantially equal to, or different from, the second scanning density. FIG. 16A illustrates that the first scanning density of the scanlines corresponding to partial FOV 1620A is greater than the second scanning density of the scanlines corresponding to partial FOV 1620B. Partial FOV 1620A may have a higher scanning density because it includes a region of interest (ROI) that requires a higher resolution scan. FIG. 16A further illustrates the partial FOV 1620A has a vertical range that is less than that of partial FOV 1620B; and the horizontal ranges of the two FOVs 1620A and 1620B may not overlap.

In another embodiment shown in FIG. 16B, partial FOV 1620A has a greater scanning density than partial FOV 1620B. In FIG. 16B, the partial FOV 1620A also has a vertical range that is less than that of partial FOV 1620B; but the horizontal ranges of the two FOVs 1620A and 1620B overlap. Therefore, the first light steering device is configured to scan at a higher scanning density but a smaller scanning range; while the second light steering device is configured to scan at a lower scanning density but a larger scanning range. Again, the first light steering device may be configured to scan an ROI area at the higher scanning density.

In FIG. 16B, compared to an optical core assembly with a single optical polygon element, multiple optical polygon elements in the multiple light steering devices create a center region of interest (ROI) with an increased point density. It is understood that the ROI area can be any area within an FOV of the LiDAR system. Thus, the multiple light steering devices of the optical core assembly may be configured in any desired manner based on the scanning requirements related to ROIs. As such, using multiple light steering devices having multiple polygon elements can improve the scanning performance, density, efficiency, and speed.

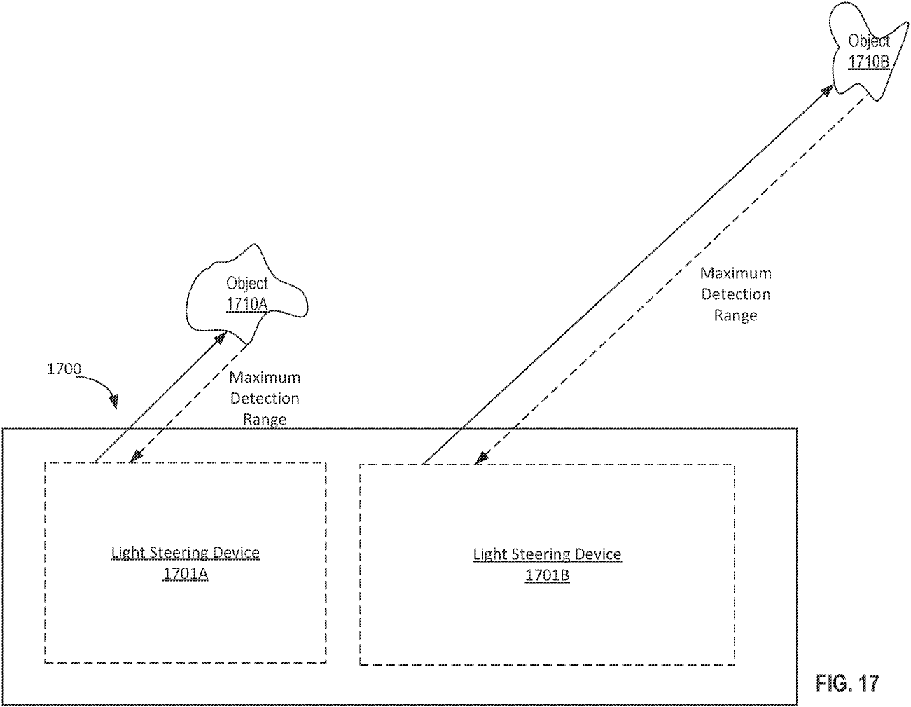

FIG. 17 illustrates maximum detection ranges of a LiDAR scanning system having an optical core assembly 1700 comprising multiple light steering devices, according to some embodiments. As illustrated in FIG. 17, similar to those described above, optical core assembly 1700 includes a first light steering device 1701A and a second light steering device 1701B. For simplicity, the other components (e.g., transceiver assemblies, light source, etc.) are not shown in FIG. 17. In one embodiment, a first maximum detection range obtainable by the first light steering device 1701A is different from a second maximum detection range obtainable by the second light steering device 1701B. For example, the first maximum detection range may be at least about 100 m; and the second maximum detection range may be about 1-250 m. in the example shown in FIG. 17, light steering device 1701A can be used to scan light for detecting a near-distance object 1710A; while light steering device 1701B can be used to scan light for detecting a far-distance object 1710B. The different maximum detection ranges obtainable by light steering devices 1701A and 1701B can be enabled by using different laser powers for the light beams provided to light steering devices 1701A and 1701B. Thus, light beams provided to light steering device 1701A may have smaller laser power than those provided to light steering device 1701B.

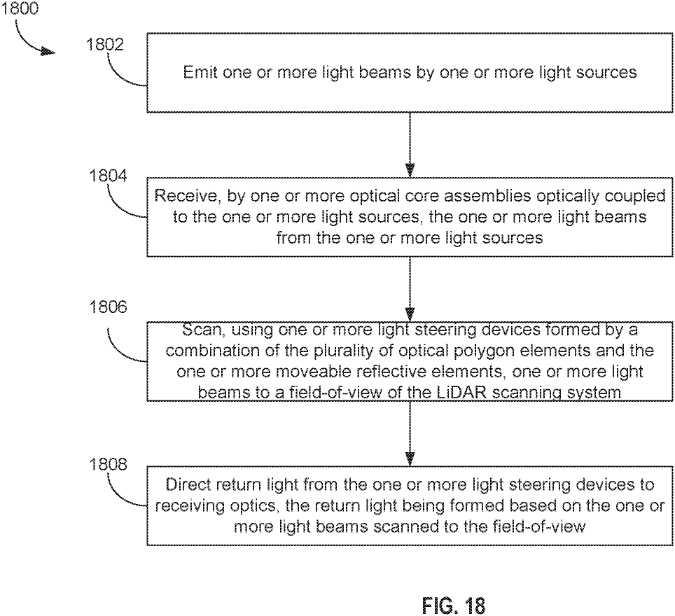

FIG. 18 is a flowchart illustrating a method 1800 performed by a LiDAR scanning system. In one embodiment, method 1800 begins with step 1802, in which one or more light sources emit one or more light beams. In step 1804, one or more optical core assemblies receive the one or more light beams from the one or more light sources. At least one of the one or more optical core assemblies comprises a plurality of optical polygon elements and one or more moveable reflective elements. One or more light steering devices can be formed by a combination of the plurality of optical polygon elements and the one or more moveable reflective elements. In step 1806, the one or more light steering devices scan the one or more light beams to a field-of-view of the LiDAR scanning system. In step 1808, the one or more light steering devices directs return light to receiving optics. The return light is formed based on the one or more light beams scanned to the field-of-view. In some embodiments, the plurality of optical polygon elements, the one or more moveable reflective elements, and at least one of the transmitting and receiving optics are disposed within an optical core assembly enclosure.

As described above, the one or more light steering devices may include a first light steering device and a second light steering device. The first light steering device comprises a first optical polygon element; and the second light steering device comprises a second optical polygon element. Thus, in one example, scanning the one or more light beams to the field-of-view comprises steering, by the first optical polygon element, a portion of the one or more light beams at least horizontally to scan a first partial field-of-view of the LiDAR scanning system, and steering, by the second optical polygon element, another portion of the one or more light beams at least horizontally to scan a second partial field-of-view. The first partial field-of-view and the second partial field-of-view form the entire field-of-view of optical core assembly of the LiDAR scanning system.

In some embodiments, for step 1806, a first light steering device scans a first partial field-of-view at a first scanning density; and a second light steering device scans a second partial field-of-view at a second scanning density. In some embodiments, scanning the one or more light beams to the field-of-view of the LiDAR scanning system may include operating the plurality of optical polygon elements in a synchronized manner, as described above.

The technologies disclosed herein are further illustrated using the below embodiments.

1. A light detection and ranging (LiDAR) scanning system used with a moveable platform, comprising:
one or more light sources;
one or more optical core assemblies optically coupled to the one or more light sources, wherein at least one optical core assembly of the one or more optical core assemblies comprises:
   an optical core assembly enclosure at least partially disposed in the moveable platform;
   a plurality of optical polygon elements, and
   one or more moveable reflective elements, wherein the combination of the plurality of optical polygon elements and the one or more moveable reflective elements form one or more light steering devices operative to scan one or more field-of-views of the LiDAR system; and
   transmitting and receiving optics,
   wherein the plurality of optical polygon elements, the one or more moveable reflective elements, and at least some of transmitting and receiving optics are disposed within the optical core assembly enclosure.

2. The system of embodiment 1, wherein the moveable platform comprises a vehicle, and wherein at least one of one or more optical core assemblies is positioned proximate to one or more pillars of a vehicle roof.

3. The system of embodiment 2, wherein the one or more pillars comprise at least one of an A-pillar, a B-pillar, a C-pillar, or a D-pillar of the vehicle roof.

4. The system of any of the previous embodiments, wherein the one or more pillars of the vehicle roof comprise first and second complementary pillars, the at least one of the one or more optical core assemblies comprising:
a first optical core assembly positioned approximately equidistant between the first and second complementary pillars of the vehicle roof.

5. The system of any of the previous embodiments, wherein the plurality of light steering device comprises a first optical polygon element and a second optical polygon elements of the plurality of optical polygon elements,
wherein the first optical polygon element is configured to steer light at least horizontally to scan a first partial field-of-view of the LiDAR scanning system, and
wherein the second optical polygon element is configured to steer light at least horizontally to scan a second partial field-of-view of the LiDAR scanning system.

6. The system of embodiment 5, wherein the first partial field-of-view and the second partial field-of-view overlap.

7. The system of embodiment 6, wherein the first partial field-of-view encompasses the second partial field-of-view.

8. The system of embodiment 6, wherein the second partial field-of-view encompasses the first partial field-of-view.

9. The system of any of the previous embodiments, wherein the at least one optical core assembly is configured to scan at least one of an asymmetric horizontal partial field-of-view or an asymmetric vertical partial field-of-view.

10. The system of any of the previous embodiments, wherein the moveable platform comprises one or more of a vehicle, a robot, an unmanned aviation vehicle (UAV), roller skates, a skateboard, a scooter, a bicycle, a tricycle, an aircraft, a watercraft, or a spacecraft.

11. The system of any of the previous embodiments, wherein the at least one optical core assembly is at least partially integrated with a planar surface of a roof of the moveable platform.

12. The system of embodiment 11, wherein the planar surface of the roof of the moveable platform comprises a substantially horizontal profile.

13. The system of embodiment 11, wherein the roof of the moveable platform comprises a complex surface profile.

14. The system of any of embodiments 11-13, wherein the at least one optical core assembly is at least partially integrated at a maximum elevation position of the roof of the moveable platform.

15. The system of any of embodiments 11-14, wherein the roof of the moveable platform is a vehicle roof comprising a roll bar or halo.

16. The system of any of the previous embodiments, wherein the at least one optical core assembly is fully embedded within the moveable platform.

17. The system of any of the previous embodiments, wherein at least one of the one or more moveable reflective elements comprises an oscillating mirror.

18. The system of any of the previous embodiments, wherein at least a portion or a side surface of the at least one optical core assembly protrudes outside of a planar surface of a roof of the moveable platform to facilitate scanning of light; and

wherein the portion of the at least one optical core assembly that protrudes outside of the planar surface of the roof of the moveable platform protrudes in a vertical direction by an amount corresponding to a lateral arrangement of the plurality of optical polygon elements, the one or more moveable reflective elements, and the transmitting and receiving optics.

19. The system of embodiment 18, wherein the amount of protrusion in the vertical direction is selected based on a vehicle aerodynamic requirement.

20. The system of any of embodiments 18-19, wherein the lateral arrangement of the plurality of optical polygon elements, the one or more moveable reflective elements, and the transmitting and receiving optics comprises:

an arrangement in which the transmitting and receiving optics and at least one of the one or more moveable reflective elements are positioned between the plurality of optical polygon elements.

21. The system of any of the previous embodiments, wherein the plurality of optical polygon elements comprises two optical polygon elements.

22. The system of any of the previous embodiments, wherein the one or more light steering devices comprise a first light steering device and a second light steering device.

23. The system of embodiment 22, wherein the first light steering device and the second light steering device are configured substantially the same or differently based on respective scanning requirements.

24. The system of any of embodiments 22 and 23, wherein the first light steering device comprises a first optical polygon element of the plurality of optical polygon elements and the second light steering device comprises:
a second optical polygon element of the plurality of optical polygon elements;
an oscillation mirror; or
a 1-dimensional micro-electromechanical system (MEMS) based optical element having an oscillation mirror base.

25. The system of embodiment 24, wherein the first optical polygon element and the second optical polygon element are substantially the same.

26. The system of embodiment 24, wherein the first optical polygon element and the second optical polygon element are configured differently such that they have one or more of:
different rotational speeds,
different rotational directions,
different numbers of the reflective surfaces,
different dimensions,
different positions and/or orientations with respect to other optical elements,
different shapes, and
different angles between adjacent reflective surfaces.

27. The system of embodiments 24-26, wherein:
the first light steering device further comprises a first moveable reflective element of the one or more moveable reflective elements;
the second light steering device further comprises a second moveable reflective element of the one or more moveable reflective elements;
the first light steering device is configured to scan a first field-of-view at a first scanning density; and
the second light steering device is configured to scan a second field-of-view at a second scanning density.

28. The system of embodiment 27, wherein the first optical polygon element and the first moveable reflective element are arranged laterally with respect to each other to reduce the dimension in the vertical direction of the first light steering device; and

wherein the second optical polygon element and the second moveable reflective element are arranged vertically with respect to each other.

29. The system of any of embodiments 27-28, wherein:
one or more dimensions of the first field-of view is substantially equal to, or different from, the second field-of-view; and/or
the first scanning density is substantially equal to, or different from, the second scanning density.

30. The system of any of embodiments 27-28, wherein:

the first field-of view does not overlap with the second field-of-view.

31. The system of any of embodiments 27-28, wherein:

the first field-of view at least partially overlaps with the second field-of-view.

32. The system of any of embodiments 27-28, wherein:
the first field-of view encompasses the second field-of-view, or
the second field-of view encompasses the first field-of-view.

33. The system of any of embodiments 27-32, wherein the first optical polygon element has one or more of a different number of reflective surfaces, a different rotational speed, or a different rotational direction than that of the second optical polygon element.

34. The system of any of embodiments 27-33, wherein the first moveable reflective element and the second moveable reflective elements are two separate moveable reflective elements.

35. The system of any of embodiments 27-33, wherein the first moveable reflective element and the second moveable reflective elements are the same moveable reflective element shared by the first light steering device and the second light steering device.

36. The system of any of embodiments 22-35, wherein the first light steering device and the second light steering device are controlled independently from each other.

37. The system of any of embodiments 22-36, wherein the first light steering device and the second light steering device share the one or more light sources.

38. The system of any of embodiments 22-36, wherein the first light steering device and the second light steering device receive light from respective light sources of the one or more light sources.

39. The system of any of embodiments 22-38, wherein the first light steering device and the second light steering device at least partially share the transmitting and receiving optics.

40. The system of any of embodiments 22-38, wherein the first light steering device and the second light steering device have respective transmitting and receiving optics.

41. The system of any of embodiments 22-40, wherein a maximum detection range obtainable by the first light steering device is different from a maximum detection range obtainable by the second light steering device.

42. The system of any of embodiments 22-41, wherein the first light steering device is configured to provide a first LiDAR detection range of at least about 100 m and the second light steering device is configured to provide a second LiDAR detection range of about 1-250 m.

43. The system of any of embodiments 22-42, wherein the one or more light resources comprise a light source providing light to both the first light steering device and the second light steering device.

44. The system of any of embodiments 22-42, wherein one or more light resources comprises at least two light sources providing light to the first light steering device and the second light steering device respectively, the at least two light sources being configured to generate light have different wavelengths to reduce crosstalk, and wherein the at least two light sources have:
one or more shared optic components including at least one of a pump laser, an optical amplifier, a combiner, a wavelength divisional multiplexer, and an optical signal path; or
separate and independent optical components.

45. The system of embodiment 44, wherein the light provided to the first light steering device comprises one or more first light beams having a 1550 nm wavelength, and the light provided to the second light steering device comprises one or more second light beams having a 1535 nm wavelength.

46. The system of any of the previous embodiments, wherein at least one light steering device of the one or more light steering devices receive a plurality of light beams from the one or more light sources, at least two of the plurality of light beams having different wavelengths.

47. The system of any of the previous embodiments, wherein the one or more optical core assemblies comprise a plurality of optical core assemblies disposed within the same optical core assembly enclosure or different optical core assembly enclosures.

48. The system of any of the previous embodiments, wherein the transmitting and receiving optics comprise one or more transmitter fiber arrays configured to deliver light to the one or more moveable reflective elements.

49. The system of embodiment 48, wherein the transmitting and receiving optics further comprise one or more collection lenses, at least one collection lens of the one or more collection lens having an opening, wherein the transmitter fiber array is at least partially disposed in the opening to deliver light to at least one of the one or more moveable reflective elements.

50. The system of embodiment 49, wherein the opening is positioned proximate to an edge of the collection lens and has a dimension configured based on an optical receiving aperture requirement.

51. The system of embodiment 50, wherein the optical receiving aperture requirement comprises a receiving performance between 0.5 and 500 meters, inclusive.

52. The system of any of embodiments 50-51, wherein the optical receiving aperture requirement is sufficient to detect a 10% target located at at least about 200 m or 250 m distance.

53. The system of any of embodiments 49-52, wherein the transmitting and receiving optics further comprise one or more receiving fiber arrays optically coupled to the one or more collection lenses.

54. The system of embodiment 53, wherein at least one of the one or more receiving fiber arrays is located adjacent to a back side of the collection lens.

55. The system of any of embodiments 53-54, wherein the receiving optics comprises one or more optical detectors.

56. The system of any of embodiments 49-55, wherein the transmitting and receiving optics further comprise an optical detector array optically coupled to the one or more collection lenses.

57. The system of any of embodiments 48-56, wherein the one or more moveable reflective elements are configured to redirect light provided by the transmitter fiber array to the optical polygon element.

58. The system of any of the previous embodiments, wherein a combination of the plurality of optical polygon elements and the one or more moveable reflective elements, when moving with respect to each other,
steers light both horizontally and vertically to illuminate one or more objects in a partial field-of-view of the LiDAR system; and
obtains return light formed based on the illumination of the one or more objects.

59. The system of any of the previous embodiments, wherein vertical positions of the plurality of optical polygon elements, at least one of the one or more movement reflective elements, and the transmitting and receiving optics are aligned to minimize an amount of protrusion of the at least one optical core assembly in the vertical direction.

60. The system of any of the previous embodiments, wherein the optical polygon element comprises a plurality of reflective surfaces, the plurality of reflective surfaces having an orientation substantially parallel, or at a non-zero angle, to a rotation axle of the optical polygon element.

61. The system of any of the previous embodiments, wherein the plurality of optical polygon elements, the one or more moveable reflective elements, and the transmitting and receiving optics are each configured to have a height of about 30 mm or less.

62. The system of any of the previous embodiments, wherein the at least one optical core assembly is configured to scan at least about 120° horizontal partial field-of-view and at least about 30° vertical partial field-of-view.

63. The system of any of the previous embodiments, wherein the at least one optical core assembly further comprises one or more windows forming a portion of an exterior surface of the optical core assembly enclosure, wherein at least one of the one or more windows is tilted at an angle configured based on at least one of an orientation of the optical polygon element or an orientation of the transmitting and receiving optics.

64. The system of embodiment 63, wherein at least one of the one or more windows comprises an antireflection coating.

65. The system of any of the previous embodiments, wherein the at least one optical core assembly protrudes outside of the moveable platform, and wherein an amount of the protrusion corresponding to a lateral arrangement of the plurality of optical polygon elements, the one or more moveable reflective elements, and the transmitting and receiving optics is reduced from an amount of protrusion corresponding to a non-lateral arrangement.

66. The system of any of the previous embodiments, wherein the at least one optical core assembly has a height of 45 mm or less.

67. The system of any of the previous embodiments, wherein the LiDAR scanning system is configured to scan greater than 120° overall field-of-view.

68. The system of any of the previous embodiments, wherein the at least one optical core assembly comprising a plurality of optical polygon elements creates a center region of interest (ROI) with an increased point density relative to an optical core assembly with a single optical polygon element.

69. The system of any of the previous embodiments, wherein at least one of the plurality of optical polygon elements comprises a motor positioned adjacent to a moveable reflective element of the one or more moveable reflective elements.

70. The system of any of the previous embodiments, further comprising two or more transceiver assemblies; wherein the two or more transceiver assemblies are optically coupled to a single light source of the one or more light sources.

71. The system of any of the previous embodiments, further comprising two or more transceiver assemblies comprising transmitting and receiving optics; wherein each of the two or more transceiver assemblies are optical coupled to a respective light source of the one or more light sources.

72. The system of any of the previous embodiments, wherein the plurality of optical polygon elements operates in a synchronized manner.

73. The system of any of the previous embodiments, wherein the plurality of optical polygon elements, when in operation, are phase-locked or in randomly different phases.

74. The system of any of the previous embodiments, further comprising two or more transceiver assemblies comprising transmitting and receiving optics; wherein the transmitting and receiving optics are physically integrated or separated.

75. A vehicle comprising a LiDAR scanning system of any of the preceding embodiments.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light detection and ranging (LiDAR) scanning system used with a moveable platform, comprising:
one or more light sources;
one or more optical core assemblies optically coupled to the one or more light sources, wherein at least one optical core assembly of the one or more optical core assemblies comprises:
an optical core assembly enclosure at least partially disposed in the moveable platform;
a plurality of optical polygon elements, and
one or more moveable reflective elements, wherein the combination of the plurality of optical polygon elements and the one or more moveable reflective elements form one or more light steering devices operative to scan a field-of-view of the LiDAR system; and
transmitting and receiving optics,
wherein the plurality of optical polygon elements, the one or more moveable reflective elements, and at least one of the transmitting and receiving optics are disposed within the optical core assembly enclosure.

2. The system of claim 1, wherein the moveable platform comprises a vehicle, and wherein at least one of one or more optical core assemblies is positioned proximate to one or more pillars of a vehicle roof.

3. The system of claim 1, wherein the one or more light steering devices comprise a first optical polygon element and a second optical polygon elements of the plurality of optical polygon elements,
wherein the first optical polygon element is configured to steer light at least horizontally to scan a first partial field-of-view of the LiDAR scanning system, and
wherein the second optical polygon element is configured to steer light at least horizontally to scan a second partial field-of-view of the LiDAR scanning system.

4. The system of claim 1, wherein the at least one optical core assembly is configured to scan at least one of an asymmetric horizontal partial field-of-view or an asymmetric vertical partial field-of-view.

5. The system of claim 1, wherein at least one of the one or more moveable reflective elements comprises an oscillating mirror.

6. The system of claim 1, wherein at least a portion or a side surface of the at least one optical core assembly protrudes outside of a planar surface of a roof of the moveable platform to facilitate scanning of light; and
wherein the portion of the at least one optical core assembly that protrudes outside of the planar surface of the roof of the moveable platform protrudes in a vertical direction by an amount corresponding to a lateral arrangement of the plurality of optical polygon elements, the one or more moveable reflective elements, and the transmitting and receiving optics.

7. The system of claim 6, wherein the lateral arrangement of the plurality of optical polygon elements, the one or more moveable reflective elements, and the transmitting and receiving optics comprises:
an arrangement in which the transmitting and receiving optics and at least one of the one or more moveable reflective elements are positioned between the plurality of optical polygon elements in a lateral direction.

8. The system of claim 1, wherein the one or more light steering devices comprise a first light steering device and a second light steering device.

9. The system of claim 8, wherein the first light steering device and the second light steering device are configured substantially the same or configured differently based on respective scanning requirements.

10. The system of claim 8, wherein the first light steering device comprises a first optical polygon element of the plurality of optical polygon elements and the second light steering device comprises a second optical polygon element of the plurality of optical polygon elements.

11. The system of claim 10, wherein the first optical polygon element and the second optical polygon element are substantially the same.

12. The system of claim 10, wherein the first optical polygon element and the second optical polygon element are configured differently such that they have one or more of:
different rotational speeds,
different rotational directions,
different numbers of the reflective surfaces,
different dimensions,
different positions and/or orientations with respect to other optical elements,
different shapes, and
different angles between adjacent reflective surfaces.

13. The system of claims 10, wherein:
the first light steering device further comprises a first moveable reflective element of the one or more moveable reflective elements;
the second light steering device further comprises a second moveable reflective element of the one or more moveable reflective elements;
the first light steering device is configured to scan a first partial field-of-view at a first scanning density; and
the second light steering device is configured to scan a second partial field-of-view at a second scanning density.

14. The system of claim 13, wherein the first optical polygon element and the first moveable reflective element are arranged laterally with respect to each other to reduce the dimension in the vertical direction of the first light steering device; and
wherein the second optical polygon element and the second moveable reflective element are arranged vertically with respect to each other.

15. The system of claim 13, wherein:
the first scanning density is different from the second scanning density.

16. The system of claim 13, wherein the first moveable reflective element and the second moveable reflective elements are the same moveable reflective element shared by the first light steering device and the second light steering device.

17. The system of claim 10, wherein at least one of the first optical polygon element or the second optical polygon element is a variable angle multiple facet polygon (VAMFP) element.

18. The system of claim 8, wherein the first light steering device and the second light steering device are controlled independently from each other.

19. The system of claim 1, wherein the transmitting and receiving optics comprise one or more collection lenses, at least one collection lens of the one or more collection lens having an opening, wherein a multiple-channel transmitter is at least partially disposed in the opening to deliver light to at least one of the one or more moveable reflective elements.

20. The system of claim 19, wherein the one or more moveable reflective elements are configured to redirect light provided by the multiple-channel transmitter to the plurality of optical polygon elements.

21. The system of claim 1, wherein a combination of the plurality of optical polygon elements and the one or more moveable reflective elements, when moving with respect to each other,
steers light both horizontally and vertically to illuminate one or more objects in a field-of-view of the LiDAR scanning system; and
obtains return light formed based on the illumination of the one or more objects.

22. The system of claim 1, wherein the at least one optical core assembly further comprises a window forming a portion of an exterior surface of the optical core assembly enclosure, wherein the windows is tilted at an angle configured based on at least one of an orientation of an optical polygon element of the plurality of optical polygon elements or an orientation of the transmitting and receiving optics.

23. The system of claim 1, wherein the plurality of optical polygon elements operates in a synchronized manner.

24. A vehicle comprising a LiDAR scanning system comprising a light detection and ranging (LiDAR) scanning system used with a moveable platform, the LiDAR system comprising:
one or more light sources;
one or more optical core assemblies optically coupled to the one or more light sources, wherein at least one optical core assembly of the one or more optical core assemblies comprises:
an optical core assembly enclosure at least partially disposed in the moveable platform;
a plurality of optical polygon elements, and
one or more moveable reflective elements, wherein the combination of the plurality of optical polygon elements and the one or more moveable reflective elements form one or more light steering devices operative to scan a field-of-view of the LiDAR system; and
transmitting and receiving optics,
wherein the plurality of optical polygon elements, the one or more moveable reflective elements, and at least one of the transmitting and receiving optics are disposed within the optical core assembly enclosure.

25. A method performed by a light detection and ranging (LiDAR) scanning system, comprising:
emitting one or more light beams by one or more light sources;
receiving, by one or more optical core assemblies optically coupled to the one or more light sources, the one or more light beams from the one or more light sources, wherein at least one of the one or more optical core assemblies comprises a plurality of optical polygon elements and one or more moveable reflective elements;
scanning, using one or more light steering devices formed by a combination of the plurality of optical polygon elements and the one or more moveable reflective elements, one or more light beams to a field-of-view of the LiDAR scanning system; and
directing return light from the one or more light steering devices to receiving optics, the return light being formed based on the one or more light beams scanned to the field-of-view, wherein the plurality of optical polygon elements, the one or more moveable reflective elements, and at least one of the transmitting and receiving optics are disposed within the optical core assembly enclosure.

26. The method of claim 25, wherein the one or more light steering devices comprise a first light steering device and a second light steering device.

27. The method of claim 26, wherein the first light steering device comprises a first optical polygon element of the plurality of optical polygon elements, wherein the second light steering device comprises a second optical polygon elements of the plurality of optical polygon elements, and wherein scanning the one or more light beams to the field-of-view comprises:
steering, by the first optical polygon element, a portion of the one or more light beams at least horizontally to scan a first partial field-of-view of the LiDAR scanning system, and
steering, by the second optical polygon element, another portion of the one or more light beams at least horizontally to scan a second partial field-of-view.

28. The method of claim 26, wherein scanning the one or more light beams to the field-of-view of the LiDAR scanning system comprises:
scanning, by the first light steering device, a first partial field-of-view at a first scanning density; and
scanning, by the second light steering device, a second partial field-of-view at a second scanning density.

29. The method of claim 26, further comprising controlling the first light steering device and the second light steering device independently from each other.

30. The method of claim 25, wherein scanning the one or more light beams to the field-of-view of the LiDAR scanning system comprises operating the plurality of optical polygon elements in a synchronized manner.
